(19) United States
(12) Patent Application Publication
(10) Pub. No.: US 2007/0243489 A1
(43) Pub. Date: Oct. 18, 2007

(54) Optical information-recording medium, method for recording information, and compound

(75) Inventor: Tetsuya Watanabe, Odawara-shi (JP)

Correspondence Address: SUGHRUE MION, PLLC, 2100 PENNSYLVANIA AVENUE, N.W., SUITE 800, WASHINGTON, DC, 20037, US

(73) Assignee: FUJIFILM Corporation, Tokyo (JP)

(21) Appl. No.: 11/783,974

(22) Filed: Apr. 13, 2007

(30) Foreign Application Priority Data
Apr. 14, 2006 (JP) 2006-112574
Apr. 28, 2006 (JP) 2006-126858

(51) Int. Cl. G11B 7/24

(52) U.S. Cl. 430/270.16; 430/945; 428/64.8

(57) ABSTRACT

A first optical information-recording medium has, on a first substrate, a first write-once type recording layer capable of recording information by being irradiated with a laser beam of not more than 440 nm, wherein the first write-once type recording layer contains a metal complex having a ligand of a compound represented by the following general formula (I):

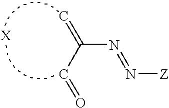

wherein Z represents:

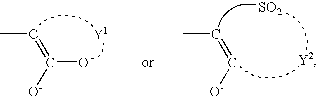

wherein each of X, Y¹, Y² independently represents an atom group for forming a five-membered or six-membered heterocyclic ring which may be condensed.

### BACKGROUND OF THE INVENTION

1. Field of the Invention

The present invention relates to an optical information-recording medium on which information can be recorded and reproduced by using a laser beam, a method for recording information, and a novel compound suitable for the optical information-recording medium. In particular, the present invention relates to an optical information-recording medium of the heat mode type suitable for recording information, using a short-wavelength laser beam having a wavelength of not more than 440 nm. The present invention also relates to a method for recording information, and a compound (metal complex).

2. Description of the Related Art

An optical information-recording medium (optical disk), on which information can be recorded only once by using a laser beam, has been hitherto known. The optical disk is also referred to as “write-once type CD” (so-called CD-R). The typical structure thereof includes a recording layer which is composed of a methine dye, a light-reflective layer which is composed of a metal such as gold, and a protective layer which is made of resin, the layers being provided in this order in a stacked state on a transparent disk-shaped substrate. Information is recorded on a CD-R by radiating a laser beam in a near infrared region (usually a laser beam having a wavelength around 780 nm) onto the CD-R. The irradiated portion of the recording layer absorbs the laser beam, and the temperature at this position is locally raised. The physical or chemical change (for example, pit formation) is thus caused to change the optical characteristic thereof, and then the information is recorded. On the other hand, information is read (reproduced) by radiating a laser beam having the same wavelength as that of the recording laser beam. The information is reproduced by detecting the difference in reflectance between the portion in which the optical characteristics of the recording layer are changed (recorded area) and the portion in which the optical characteristics are not changed (unrecorded area).

Recently, the network such as the Internet and the high-definition television are rapidly widespread. The digital HDTV (High Definition Television) will become common soon. In view of these circumstances, a recording medium having a large capacity in order to record the image information inexpensively and conveniently is highly demanded. Although CD-Rs described above and DVD-Rs which enable the high density recording by using a visible laser beam (630 nm to 680 nm) as the recording laser beam are expected to be used as a large-capacity recording medium in the future. However, it is not affirmed that such recording mediums do not have a large recording capacity sufficient to meet expected requirements for much larger capacity. In view of the above, an optical disk having improved recording density and recording capacity by using a laser beam having a wavelength shorter than that for DVD-R is progressively developed. For example, an optical recording disk has been commercially available, which utilizes the so-called Blu-ray system based on the use of a blue laser at 405 nm.

A recording and reproducing method has been hitherto disclosed, in which information is recorded and reproduced by radiating a laser beam having a wavelength of not more than 530 nm from a recording layer side to a light-reflective layer side on an optical information-recording medium having a recording layer containing an organic dye.

Specifically, an information recording and reproducing method has been proposed, in which information is recorded and reproduced by radiating blue (wavelength: 400 to 430 nm, 488 nm) or blue-green (wavelength: 515 nm) laser beams onto an optical disk that contains, as dyes of a recording layer, for example, a porphyrin compound, an azo-based dye, a metal azo-based dye, a quinophthalone-based dye, a trimethine cyanine dye, a dicyanovinylphenyl skeleton dye, a coumarin compound, or a naphthalocyanine compound. Further, an information recording and reproducing method has been proposed, in which information is recorded and reproduced by radiating a laser beam having a wavelength of not more than 550 nm onto an optical disk which contains on the use of an oxonol dye as the dye of a recording layer.

The conventional techniques, which relate to the dye for the recording disk adapted to the blue laser beam as described above, include those described in the following patent documents.

U.S. Pat. No. 6,969,764;

United States Patent Publication No. 2002/076648;

United States Patent Publication No. 2003/138728;

WO 2006/013214 A1; and

Japanese Laid-Open Patent Publication No. 2001-158862.

### SUMMARY OF THE INVENTION

However, according to the study by the present inventors, the optical disk, which uses the known dye described in the patent documents described above, is not practically satisfactory in light resistance and the recording characteristics. The present inventors have found out the fact that the foregoing problem can be solved by using a dye having a specified structure. Thus, the present invention has been completed.

An object of the present invention is to provide an optical information-recording medium in which the high density recording and the high density reproduction of information are satisfactorily performed by radiating a laser beam of not more than 440 nm, and the storage performance is satisfactory.

Another object of the present invention is to provide an information recording method which makes it possible to record information at a high density by radiating a laser beam of not more than 440 nm.

Still another object of the present invention is to provide a compound (metal complex) which makes it possible to record information at a high density by being irradiated with a laser beam of not more than 440 nm and which is suitable for an optical information-recording medium having satisfactory storage performance.

The objects of the present invention have been favorably achieved by the following constructions.

(1) An optical information-recording medium having, on a substrate, a recording layer capable of recording information by being irradiated with a laser beam having a wavelength of not more than 440 nm, wherein:

the recording layer contains a metal complex having a ligand of a compound represented by the following general formula (I):

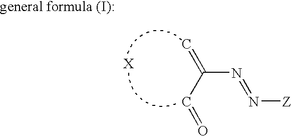

wherein Z represents

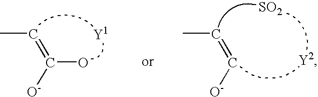

wherein each of X, Y¹, Y² independently represents an atom group for forming a five-membered or six-membered heterocyclic ring which may be condensed.

(2) The optical information-recording medium according to (1), wherein the five-membered or six-membered heterocyclic ring formed by the atom group represented by Y² in the general formula (I), which may be condensed, contains no nitrogen atom.

(3) The optical information-recording medium, wherein the ligand of the general formula (I) is a compound represented by the following general formula (IIa):

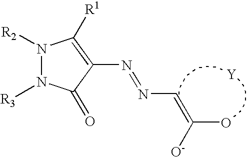

wherein Y represents an atom group forming a five-membered or six-membered heterocyclic ring which may be condensed, and each of R1, R2, and R3 independently represents a hydrogen atom or a substituent.

(4) The optical information-recording medium according to (1), wherein the ligand of the general formula (I) is a compound represented by the following general formula (IIb):

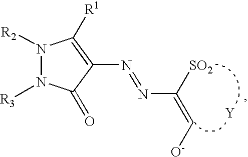

wherein Y represents an atom group forming a five-membered or six-membered heterocyclic ring which may be condensed, and each of R1, R2, and R3 independently represents a hydrogen atom or a substituent.

(5) The optical information-recording medium according to (4), wherein the five-membered or six-membered heterocyclic ring formed by the atom group represented by Y in the general formula (IIb), which may be condensed, contains no nitrogen atom.

(6) The optical information-recording medium, wherein the metal complex having the ligand of the compound represented by the general formula (I) is a compound represented by the following general formula (IIIa):

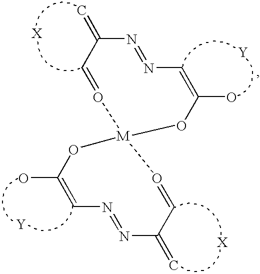

wherein broken lines represent coordinate bonds, each of X and Y independently represents an atom group forming a five-membered or six-membered heterocyclic ring which may be condensed, and M is any one of Ni, Cu, Co, Zn, Al, Fe, Pd, Cr, and Mn.

(7) The optical information-recording medium, wherein the metal complex having the ligand of the compound represented by the general formula (I) is a compound represented by the following general formula (IIIb):

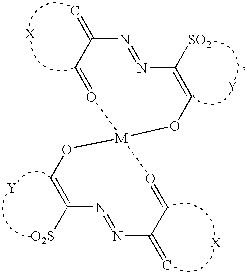

wherein broken lines represent coordinate bonds, each of X and Y independently represents an atom group forming a five-membered or six-membered heterocyclic ring which may be condensed, and M is any one of Ni, Cu, Co, Zn, Al, Fe, Pd, Cr, and Mn.

(8) The optical information-recording medium according to (1), wherein the substrate is a transparent disk-shaped substrate which has a pregroove having a track pitch of 50 to 600 nm on a surface, and the recording layer is provided on the surface of the substrate disposed on a side on which the pregroove is formed.

(9) The optical information-recording medium according to (1), wherein a light-reflective layer, which is composed of a metal, is provided distinctly from the recording layer.

(10) The optical information-recording medium according to (1), wherein a protective layer is provided distinctly from the recording layer.

According to another aspect of the present invention, there is provided an information-recording method comprising recording information by radiating a laser beam having a wavelength of not more than 440 nm onto the optical information-recording medium as defined in any one of (1) to (9).

According to still another aspect of the present invention, there is provided a compound (metal complex) preferred as a dye for an optical information-recording medium for recording information by being irradiated with a laser beam having a wavelength of not more than 440 nm, the compound being represented by the following general formula (IVa):

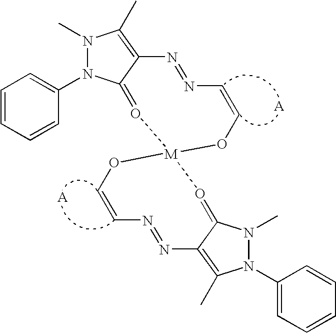

wherein broken lines represent coordinate bonds, A represents an atom group selected from the following group 1a, and M is any one of Ni, Cu, Co, Zn, and Cr, the group 1a being as follows:

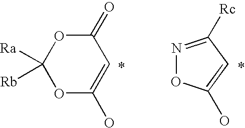

wherein each of Ra, Rb, and Rc represents a hydrogen atom or a substituent, the respective substituents may be bonded to one another to form a ring, and a symbol * indicates the position of bonding to an azo group.

According to still another aspect of the present invention, there is provided a compound (metal complex) preferred as a dye for an optical information-recording medium for recording information by being irradiated with a laser beam having a wavelength of not more than 440 nm: the compound being represented by the following general formula (IVb):

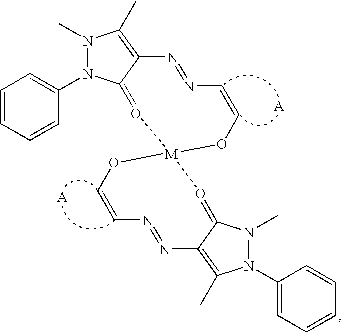

wherein broken lines represent coordinate bonds, A represents an atom group selected from the following group 1b, and M is any one of Ni, Cu, Co, Zn, and Cr: the group 1b being as follows:

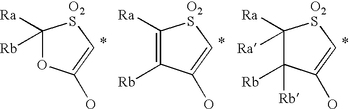

wherein each of Ra, Ra′, Rb, and Rb′ represents a hydrogen atom or a substituent, the respective substituents may be bonded to one another to form a ring, and a symbol * indicates a position of bonding to an azo group.

The ligand of the metal complex contained in the recording layer of the optical information-recording medium of the present invention and the ligand of the compound (metal complex) of the present invention have the following features: (1) the heterocyclic group containing CO₂ group or SO₂ group is included in the structure; and (2) the ligand forms the neutral complex in which no counterion is required to neutralize an electric charge when the ligand is coordinated with any divalent metal ion, because the ligand is a monoanion ligand.

When the ligand, which includes the heterocyclic ring containing CO₂ group or SO₂ group in the structure, is used, the ratio of decomposition is raised when the metal complex is heated and decomposed, which is especially preferred as the recording dye for the optical information-recording medium for recording in a heat mode. When the neutral complex is formed, the ratio of decomposition is also raised when the metal complex is heated and decomposed, because of the absence of the counterion portion remaining after thermal decomposition, which is preferred as the recording dye. Additionally, an unexpected result has been obtained such that wet heat durability of the optical information-recording medium containing the metal complex is enhanced owing to the enhancement of the hydrophobicity.

U.S. Pat. No. 4,960,870 discloses a metal complex having a ligand of an azo dye including a heterocyclic ring containing SO₂ group in the structure, which is similar to the compound (metal complex) of the present invention. However, U.S. Pat. No. 4,960,870 discloses only such a case in which the azo dye to serve as the ligand is coordinated with the metal as dianion, and any counterion is required to neutralize the electric charge other than the metal complex portion.

WO 2006/013241 A1 discloses a neutral azo metal complex which is preferably as an optical information-recording medium. The azo dye in WO 2006/013241 A1 has such a feature that the nitrogen atom is substituted adjacently to the carbon atom wherein the oxygen atom to be dissociated and coordinated with the metal is substituted. However, the thermal decomposition characteristics of the metal complex having the ligand of the azo dye containing the heterocyclic ring of the structure as described above are insufficient for our request.

As explained above, according to the optical information-recording medium concerning the present invention, the high density recording and the high density reproduction of information are satisfactorily performed by radiating the laser beam of not more than 440 nm, and quality of recorded information is kept high.

According to the optical information-recording medium concerning the present invention, it is possible to record information at a high density by radiating a laser beam of not more than 440 nm.

When the compound (metal complex) concerning the present invention is used, it is possible to obtain an optical information-recording medium which exhibits satisfactory recording and reproduction characteristics and which keeps high quality of recorded information. In particular, the effect as described above is obtained by using the laser beam having the wavelength shorter than those for the CD-Rs and the DVD-Rs. Therefore, it is possible to provide the higher density information-recording medium and the recording and reproducing method.

The above and other objects, features, and advantages of the present invention will become more apparent from the following description when taken in conjunction with the accompanying drawings in which a preferred embodiment of the present invention is shown by way of illustrative example.

### BRIEF DESCRIPTION OF THE DRAWINGS

FIG. 1 is a table showing preferred specified exemplary metal complexes to be used in the present invention;

FIG. 2 is a table showing other preferred specified exemplary metal complexes to be used in the present invention;

FIG. 3 is a cross-sectional view, with partial omission, showing a first optical information-recording medium;

FIG. 4 is a cross-sectional view, with partial omission, showing a second optical information-recording medium;

FIG. 5 is a table showing evaluation results of C/N (carrier-to-noise ratio) for Examples 1 to 10 and Comparative Examples 1 to 4; and

FIG. 6 is a table showing evaluation results of C/N (carrier-to-noise ratio) for Examples 11 to 20 and Comparative Examples 1 to 4.

### DESCRIPTION OF THE PREFERRED EMBODIMENTS

The optical information-recording medium of the present invention is characterized in that the recording layer contains a metal complex having a ligand of a compound represented by the following general formula (Ia):

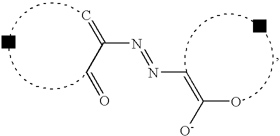

wherein each of X and Y independently represents an atom group forming a five-membered or six-membered heterocyclic ring which may form a condensed ring.

Further, the optical information-recording medium of the present invention is characterized in that the recording layer contains a metal complex having a ligand of a compound represented by the following general formula (Ib):

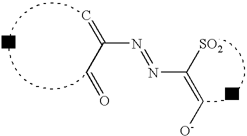

wherein each of X and Y independently represents an atom group forming a five-membered or six-membered heterocyclic ring which may form a condensed ring.

In the general formula (Ia) and the general formula (Ib), examples of the heterocyclic ring represented by X include the followings (see formula (X-1) to formula (X-10)). In the respective formulas, each of R1, R2, and R3 represents a hydrogen atom or a substituent. The symbol * indicates the position of bonding to the azo group.

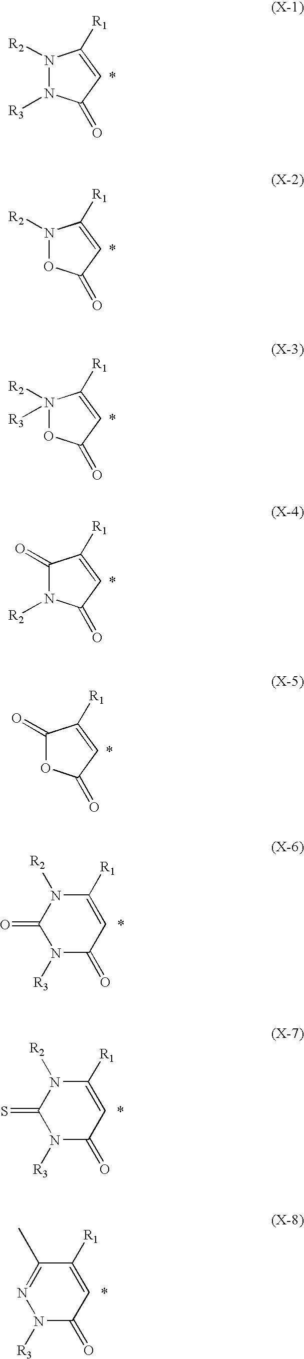

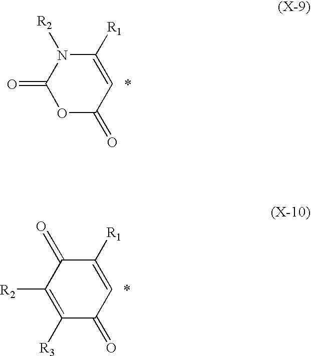

In the formulas (X-1) to (X-10), the heterocyclic rings represented by X of the general formulas (Ia) and (Ib) are preferably the heterocyclic ring represented by the formula (X-1) in view of the stability and the wavelength characteristics.

In the formula (X-1), examples of the case in which R1, R2, and R3 are substituents include the followings:

(1) substituted or unsubstituted, and linear, branched, or cyclic alkyl group-having 1 to 18 carbon atoms, preferably 1 to 8 carbon atoms, for example, methyl, ethyl, propyl, isopropyl, n-butyl, isobutyl, sec-butyl, t-butyl, cyclohexyl, methoxyethyl, ethoxycarbonylethyl, cyanoethyl, diethylaminoethyl, hydroxyethyl, chloroethyl, acetoxyethyl, and trifluoromethyl;

(2) alkenyl group having 2 to 18 carbon atoms, preferably 2 to 8 carbon atoms, for example, vinyl;

(3) alkynyl group having 2 to 18 carbon atoms, preferably 2 to 8 carbon atoms, for example, ethinyl;

(4) substituted or unsubstituted aryl group having 6 to 18 carbon atoms, preferably 6 to 10 carbon atoms, for example, phenyl, 4-methylphenyl, 4-methoxyphenyl, 4-carboxyphenyl, and 3,5-dicarboxyphenyl;

(5) substituted or unsubstituted aralkyl group having 7 to 18 carbon atoms, preferably 7 to 12 carbon atoms, for example, benzyl and carboxybenzyl;

(6) substituted or unsubstituted acyl group having 2 to 18 carbon atoms, preferably 2 to 8 carbon atoms, for example, acetyl, propionyl, butanoyl and chloroacetyl;

(7) substituted or unsubstituted alkyl or arylsulfonyl group having 1 to 18 carbon atoms, preferably 1 to 8 carbon atoms, for example, methanesulfonyl and p-toluenesulfonyl;

(8) alkylsulfinyl group having 1 to 18 carbon atoms, preferably 1 to 8 carbon atoms, for example, methanesulfinyl, ethanesulfinyl and octanesulfinyl;

(9) alkoxycarbonyl group having 2 to 18 carbon atoms, preferably 2 to 8 carbon atoms, for example, methoxycarbonyl, ethoxycarbonyl, and butoxycarbonyl;

(10) aryloxycarbonyl group having 7 to 18 carbon atoms, preferably 7 to 12 carbon atoms, for example, phenoxycarbonyl, 4-methylphenoxycarbonyl, and 4-methoxyphenylcarbonyl;

(11) substituted or unsubstituted alkoxy group having 1 to 18 carbon atoms, preferably 1 to 8 carbon atoms, for example, methoxy, ethoxy, n-butoxy, and methoxyethoxy;

(12) substituted or unsubstituted aryloxy group having 6 to 18 carbon atoms, preferably 6 to 10 carbon atoms, for example, phenoxy and 4-methoxyphenoxy;

(13) alkylthio group having 1 to 18 carbon atoms, preferably 1 to 8 carbon atoms, for example, methylthio and ethylthio;

(14) arylthio group having 6 to 10 carbon atoms, preferably 6 to 8 carbon atoms, for example, phenylthio;

(15) substituted or unsubstituted acyloxy group having 2 to 18 carbon atoms, preferably 2 to 8 carbon atoms, for example, acetoxy, ethylcarbonyloxy, cyclohexylcarbonyloxy, benzoyloxy, and chloroacetyloxy;

(16) substituted or unsubstituted sulfonyloxy group having 1 to 18 carbon atoms, preferably 1 to 8 carbon atoms, for example, methanesulfonyloxy;

(17) substituted or unsubstituted carbamoyloxy group having 2 to 18 carbon atoms, preferably 2 to 8 carbon atoms, for example, methylcarbamoyloxy and diethylcarbamoyloxy;

(18) unsubstituted amino group or substituted amino group having 1 to 18 carbon atoms, preferably 1 to 8 carbon atoms, for example, methylamino, dimethylamino, diethylamino, anilino, methoxyphenylamino, chlorophenylamino, pyridylamino, methoxycarbonylamino, n-butoxycarbonylamino, phenoxycarbonylamino, phenylcarbamoylamino, ethylthiocarbamoylamino, methylsulfamoylamino, phenylsulfamoylamino, ethylcarbonylamino, ethylthiocarbonylamino, cyclohexylcarbonylamino, benzoylamino, chloroacetylamino, methanesulfonylamino, and benzenesulfonylamino;

(19) amide group having 1 to 18 carbon atoms, preferably 1 to 8 carbon atoms, for example, acetamide, acetylmethylamide, and acetyloctylamide;

(20) substituted or unsubstituted ureido group having 1 to 18 carbon atoms, preferably 1 to 8 carbon atoms, for example, unsubstituted ureido, methylureido, ethylureido, and dimethylureido;

(21) substituted or unsubstituted carbamoyl group having 1 to 18 carbon atoms, preferably 1 to 8 carbon atoms, for example, unsubstituted carbamoyl, methylcarbamoyl, ethylcarbamoyl, n-butylcarbamoyl, t-butylcarbamoyl, dimethylcarbamoyl, morpholinocarbamoyl, and pyrrolidinocarbamoyl;

(22) unsubstituted sulfamoyl group or substituted sulfamoyl group having 1 to 18 carbon atoms, preferably 1 to 8 carbon atoms, for example, methylsulfamoyl and phenylsulfamoyl;

(23) halogen atom, for example, fluorine, chlorine, and bromine;

(24) hydroxyl group;

(25) mercapto group;

(26) nitro group;

(27) cyano group;

(28) carboxyl group;

(29) sulfo group;

(30) phosphono group, for example, diethoxyphosphono; and

(31) heterocyclic group, for example, oxazole ring, benzooxazole ring, thiazole ring, benzothiazole ring, imidazole ring, benzoimidazole ring, indolenine ring, pyridine ring, morpholine ring, piperidine ring, pyrrolidine ring, sulfolane ring, furan ring, thiophene ring, pyrazole ring, pyrrole ring, chroman ring, and coumarin ring.

Each of R1 and R2 is preferably an alkyl group having 1 to 18 carbon atoms, and most preferably a methyl group.

R3 is preferably a substituted or unsubstituted aryl group or a heterocyclic group having 6 to 18 carbon atoms, and most preferably a substituted or unsubstituted aryl group having 6 to 10 carbon atoms.

Examples of the heterocyclic ring represented by Y in the general formula (Ia) include the following compounds (see formula (Y-1a) to formula (Y-8a)). Each of Ra, Rb, Rc, and Rd represents a hydrogen atom or a substituent. The respective substituents may be bonded to one another to form a ring. The symbol * indicates the position of bonding to the azo group.

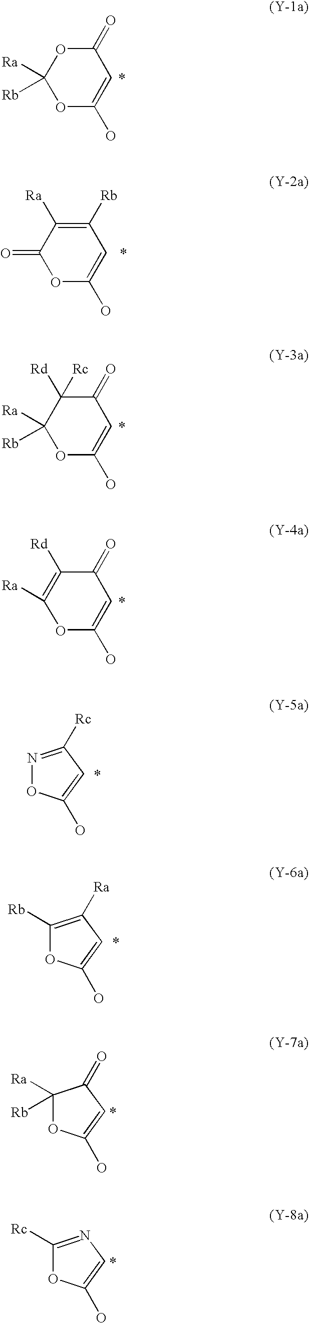

Examples of Ra, Rb, and Rc in the formula (Y-1a) and the formula (Y-5a) include those referred to as examples of R1, R2, and R3 described above.

The heterocyclic ring represented by Y in the general formula (Ia) is preferably the heterocyclic ring represented by the formula (Y-1a) or the formula (Y-5a) in view of stability and the wavelength characteristics.

In the formula (Y-1a), it is preferable that Ra and Rb are bonded to one another to form a ring. Ra and Rb more preferably form a saturated carbon ring having 3 to 7 carbon atoms is formed, most preferably, a cyclopentane ring or a cyclohexane ring.

In the formula (Y-5a), Rc is preferably an alkyl group having 1 to 18 carbon atoms, or a substituted or unsubstituted aryl group or heterocyclic group having 6 to 18 carbon atoms. Most preferably, Rc is a substituted or unsubstituted aryl group having 6 to 10 carbon atoms.

Examples of the heterocyclic ring represented by Y in the general formula (Ib) include the following compounds (see formula (Y-1b) to formula (Y-8b)). Each of Ra, Ra′, Rb, Rb′, and Rc represents a hydrogen atom or a substituent. The respective substituents may be bonded to one another to form a ring. The symbol * indicates the position of bonding to the azo group.

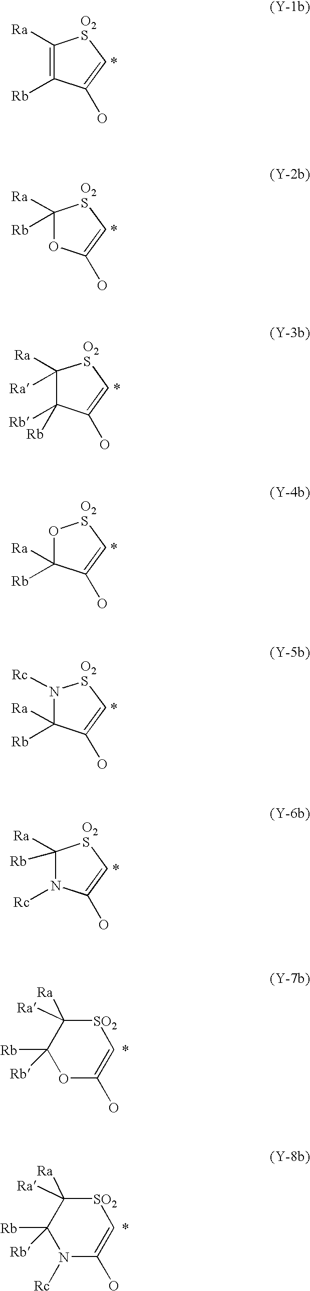

Examples of Ra, Ra′, Rb, Rb′, and Rc in the formula (Y-1b) to the formula (Y-8b) include those referred to as examples of R1, R2, and R3 described above.

The heterocyclic ring represented by Y in the general formula (Ib) is preferably the heterocyclic ring represented by the formula (Y-1b), the formula (Y-2b), or the formula (Y-3b) in view of the stability and the wavelength characteristics.

In the formula (Y-1b), it is preferable that Ra and Rb are bonded to one another to form a ring. Ra and Rb more preferably form a substituted or unsubstituted aryl group or heterocyclic group having 6 to 18 carbon atoms, most preferably, a substituted or unsubstituted aryl group having 6 to 10 carbon atoms.

In the formula (Y-2b), it is preferable that Ra and Rb are bonded to one another to form a ring. Ra and Rb more preferably form a saturated carbon ring having 3 to 7 carbon atoms, most preferably, a cyclopentane ring or a cyclohexane ring.

In the formula (Y-3b), it is preferable that Ra and Ra′ are bonded to one another to form a ring. Ra and Rb more preferably form a saturated carbon ring having 3 to 7 carbon atoms, most preferably, a cyclopentane ring or a cyclohexane ring. Each of Rb, Rb′ is preferably a hydrogen atom, an alkyl group having 1 to 18 carbon atoms, or a substituted or unsubstituted aryl group or heterocyclic group having 6 to 18 carbon atoms, most preferably a hydrogen atom.

The metal with which the ligands of the general formulas (Ia) and (Ib) are coordinated is not limited, and preferably Ni, Cu, Co, Zn, Al, Fe, Pd, Cr, or Mn, more preferably Ni, Cu, Co, Zn, or Cr, and most preferably Ni or Cu.

Examples of the ligand represented by the general formula (Ia) to be used in the present invention are specifically exemplified below (see formula (I-1a) to formula (I-16a)). However, the present invention is not limited thereto.

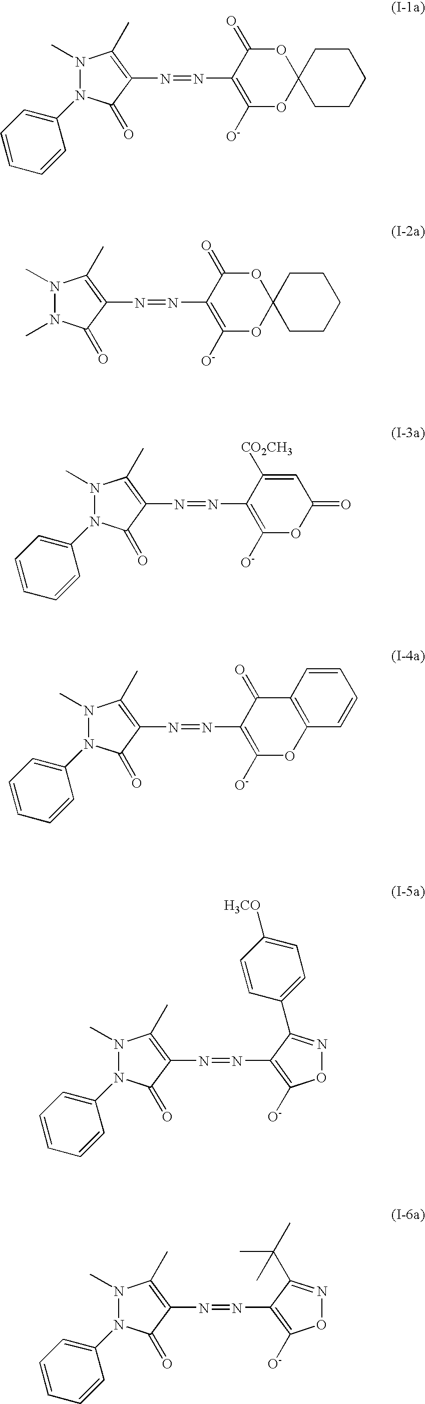

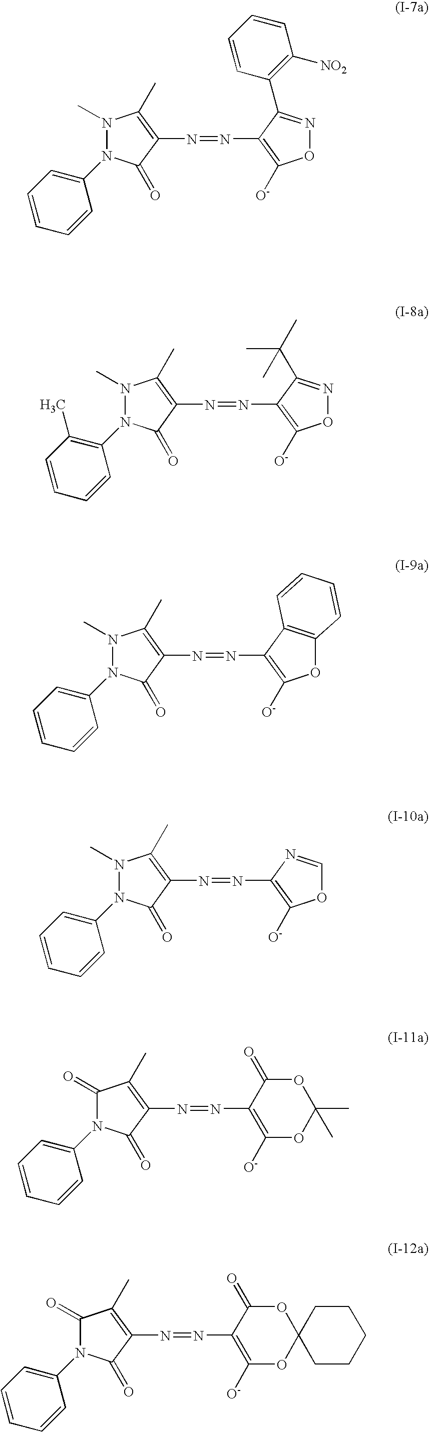

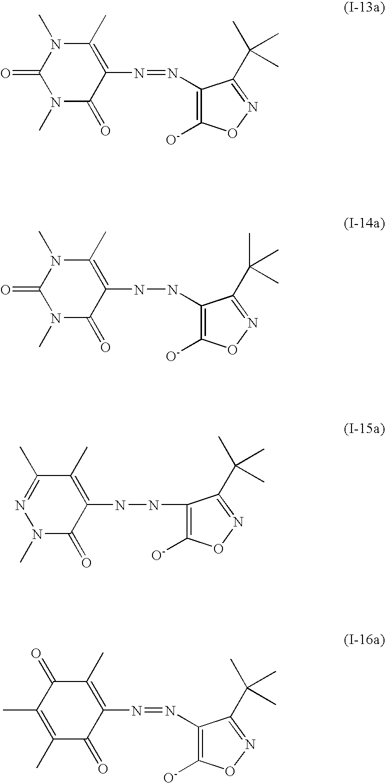

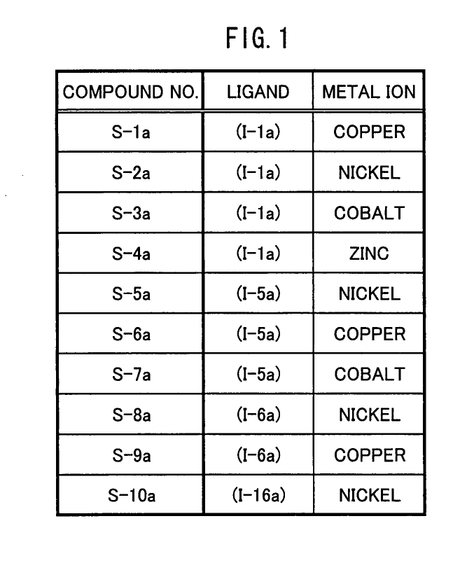

FIG. 1 shows specified examples of the metal complex represented by the general formula (Ia) to be used in the present invention. The metal complex of the present invention is provided by combining the ligand and the center metal ion. In the case of those shown in FIG. 1, the complex is formed at a ratio of one metal ion with respect to two ligands.

Examples of the ligand represented by the general formula (Ib) to be used in the present invention are specifically exemplified below (see formula (I-1b) to formula (I-16b)). However, the present invention is not limited thereto.

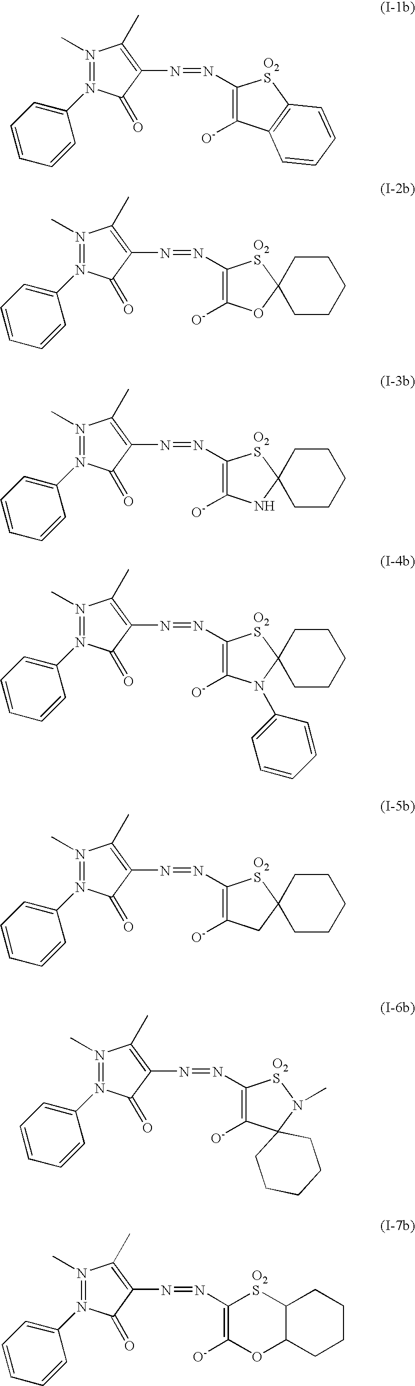

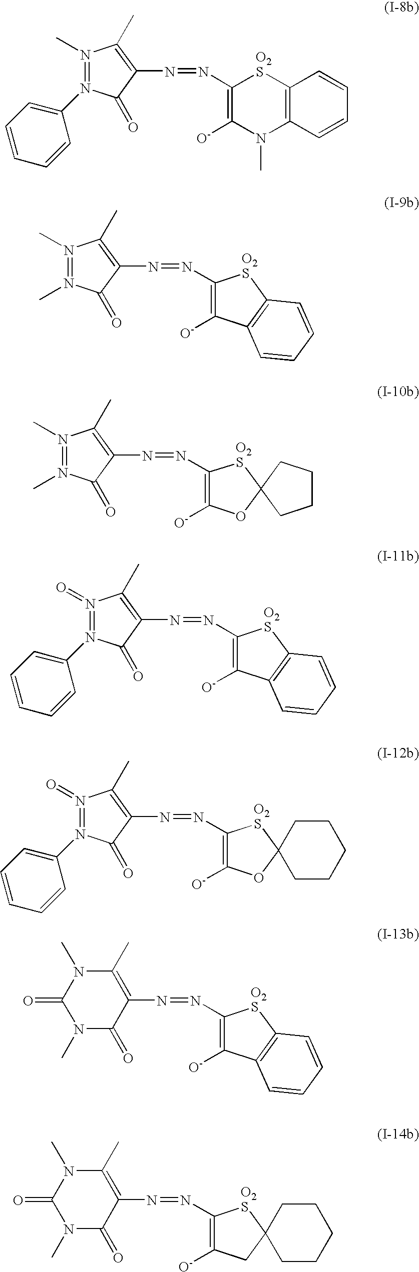

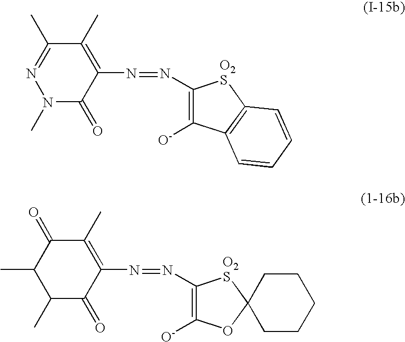

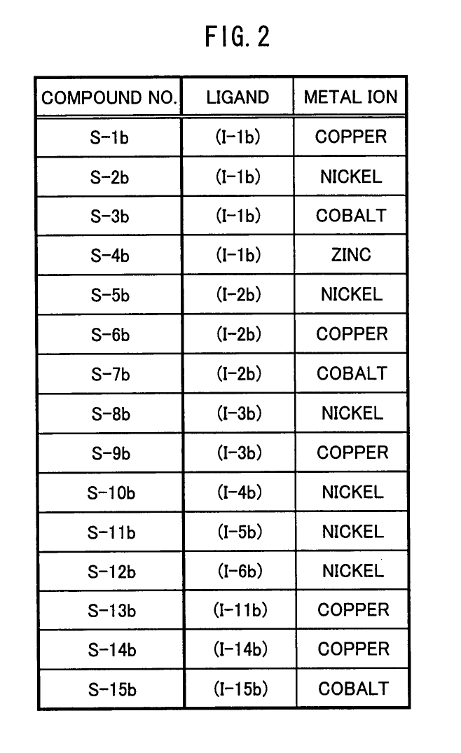

FIG. 2 shows specified examples of the metal complex represented by the general formula (Ib) to be used in the present invention. The metal complex of the present invention is provided by combining the ligand and the center metal ion. In the case of those shown in FIG. 2, the complex is formed at a ratio of one metal ion with respect to two ligands.

### Embodiments of Optical Information-Recording Medium

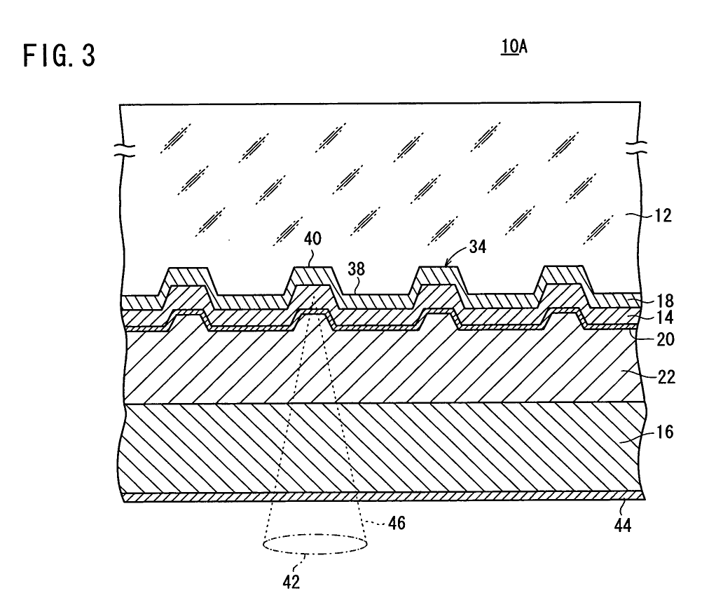

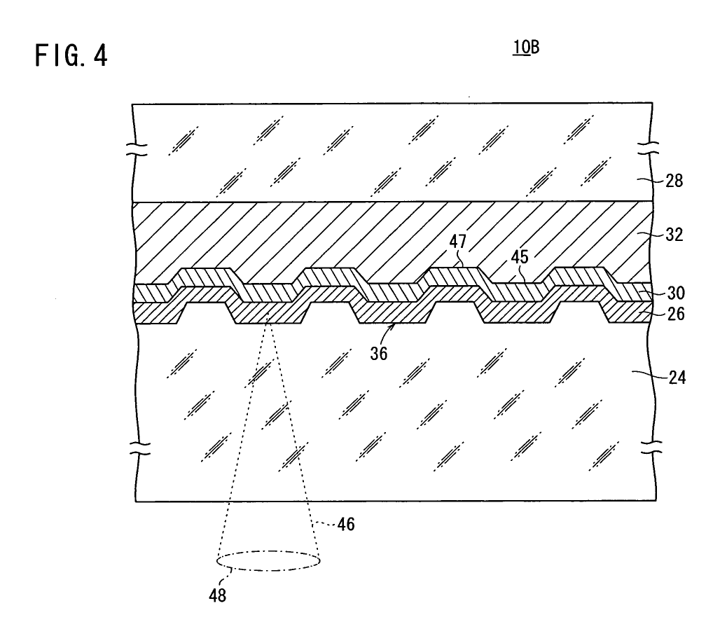

The optical information-recording medium of the present invention is preferably exemplified by an optical information-recording medium according to a first embodiment shown in FIG. 3 (hereinafter simply referred to as “first optical information-recording medium 10A”) and an optical information-recording medium according to a second embodiment shown in FIG. 4 (hereinafter simply referred to as “second optical information-recording medium 10B”).

As shown in FIG. 3, the first optical information-recording medium 10A has a first write-once type recording layer 14 which contains a dye, and a cover layer 16 which has a thickness of 0.01 to 0.5 mm, in this order on a first substrate 12 which has a thickness of 0.7 to 2 mm. Specifically, the first optical information-recording medium 10A has, for example, a first light-reflective layer 18, the first write-once type recording layer 14, a barrier layer 20, a first adhesive layer 22, and the cover layer 16 in this order on the first substrate 12.

As shown in FIG. 4, the second optical information-recording medium 10B has a second write-once type recording layer 26 which contains a dye, and a protective substrate 28 which has a thickness of 0.1 to 1.0 mm, in this order on a second substrate 24 which has a thickness of 0.1 to 1.0 mm. Specifically, the second optical information-recording medium 10B has, for example, the second write-once type recording layer 26, a second light-reflective layer 30, a second adhesive layer 32, and the protective substrate 28 in this order on the second substrate 24.

As shown in FIG. 3 it is preferable for the first optical information-recording medium 10A that a first pregroove 34 formed on the first substrate 12 has a track pitch of 50 to 500 nm, a groove width of 25 to 250 nm, and a groove depth of 5 to 150 nm.

As shown in FIG. 4 it is preferable for the second optical information-recording medium 10B that a second pregroove 36 formed on the second substrate 24 has a track pitch of 200 to 600 nm, a groove width of 50 to 300 nm, a groove depth of 30 to 200 nm, and a wobble amplitude of 10 to 50 nm.

As shown in FIG. 3, the first optical information-recording medium 10A has such a form that at least the first substrate 12, the first write-once type recording layer 14, and the cover layer 16 are provided. At first, an explanation will be made about members essential for these components.

### First Substrate 12 of First Optical Information-Recording Medium 10A

As shown in FIG. 3, it is essential that the first pregroove 34 (guide groove), which has such a shape that all of the track pitch, the groove depth, the groove width (half value of width: width of the groove at the point of ½ of the groove depth), and the wobble amplitude are within the following ranges, is formed on the first substrate 12 of the preferred first optical information-recording medium 10A. The first pregroove 34 is provided in order to achieve the recording density higher than those of CD-Rs and DVD-Rs. High recording density is preferred, for example, when the first optical information-recording medium 10A is used as a medium adapted to the blue-violet laser.

It is essential that the track pitch of the first pregroove 34 is within a range of 50 to 500 nm. The upper limit value is preferably not more than 420 nm, more preferably not more than 370 nm, and much more preferably not more than 330 nm. The lower limit value is preferably not less than 100 nm, more preferably not less than 200 nm, and much more preferably not less than 260 nm.

If the track pitch is less than 50 nm, it is difficult to form the first pregroove 34 correctly. Further, the crosstalk tends to arise. If the track pitch exceeds 500 nm, the recording density is lowered.

It is appropriate that the groove width (half value of width) of the first pregroove 34 is within a range of 25 to 250 nm. Further, the upper limit value is preferably not more than 200 nm, more preferably not more than 170 nm, and much more preferably not more than 150 nm. The lower limit value is preferably not less than 50 nm, more preferably not less than 80 nm, and much more preferably not less than 100 nm.

If the groove width of the first pregroove 34 is less than 25 nm, then the groove is not transferred sufficiently during the formation in some cases, and the error rate may be raised during the recording in other cases. If the groove width exceeds 250 nm, the pit formed upon the recording is consequently widened. The crosstalk is caused in some cases, and sufficient modulation degree is not obtained in other cases.

It is appropriate that the groove depth of the first pregroove 34 is within a range of 5 to 150 nm. The upper limit value is preferably not more than 100 nm, more preferably not more than 70 nm, and much more preferably not more than 50 nm. The lower limit value is preferably not less than 10 nm, more preferably not less than 20 nm, and much more preferably not less than 28 nm.

If the groove depth of the first pregroove 34 is less than 5 nm, sufficient recording modulation degree may not be obtained. If the groove depth exceeds 150 nm, the reflectance may greatly be lowered.

As for the angle of groove inclination of the first pregroove 34, the upper limit value is preferably not more than 80°more preferably not more than 70°, much more preferably not more than 60°, and especially preferably not more than 50°. The lower limit value is preferably not less than 20°, more preferably not less than 30°, and much more preferably not less than 40°.

If the angle of groove inclination of the first pregroove 34 is less than 20°, any sufficient tracking error signal amplitude may not be obtained. If the angle of groove inclination exceeds 80°, it is difficult to form the first substrate 12, for example, by injection molding.

Various materials having been used as the substrate material for conventional optical information-recording mediums can be arbitrarily used for the first substrate 12 for the first optical information-recording medium 10A.

Specifically, examples of the substrate material include glass; acrylic resin such as polycarbonate and polymethyl methacrylate; vinyl chloride-based resin such as polyvinyl chloride and vinyl chloride copolymer; epoxy resin; amorphous polyolefin; polyester; and metal such as aluminum. These materials may be used in combination, if desired.

Among the materials described above, the thermoplastic resin such as amorphous polyolefin and polycarbonate is preferred, and polycarbonate is especially preferred, in view of, for example, the humidity resistance, the dimensional stability, and the low price.

When the resin as described above is used, the first substrate 12 can be manufactured by using injection molding.

It is appropriate that the thickness of the first substrate 12 is within a range of 0.7 to 2 mm. The thickness is preferably within a range of 0.9 to 1.6 mm, and more preferably 1.0 to 1.3 mm.

It is preferable that an undercoat layer is formed on the surface of the first substrate 12 on the side on which the first light-reflective layer 18 is provided as described later on in order to impart the flatness and improve adhesive force.

Examples of the material for the undercoat layer include high molecular weight compounds such as polymethyl methacrylate, acrylic acid-methacrylic acid copolymer, styrene-maleic anhydride copolymer, polyvinyl alcohol, N-methylolacrylamide, styrene-vinyltoluene copolymer, chlorosulfonated polyethylene, nitrocellulose, polyvinyl chloride, chlorinated polyolefin, polyester, polyimide, vinyl acetate-vinyl chloride copolymer, ethylene-vinyl acetate copolymer, polyethylene, polypropylene, and polycarbonate; and surface-modifying agents such as a silane coupling agent.

The undercoat layer can be formed such that the material as described above is dissolved or dispersed in an appropriate solvent to prepare a coating liquid, and the surface of the first substrate 12 is coated with the coating liquid by a coating method such as the spin coating, the dip coating, and the extrusion coating. The layer thickness of the undercoat layer is generally within a range of 0.005 to 20 μm, and preferably within a range of 0.01 to 10 μm.

### First Write-Once Type Recording Layer 14 of First Optical Information-Recording Medium 10A

The first write-once type recording layer 14 of the preferred first optical information-recording medium 10A is formed as follows. That is, a dye is dissolved together with a binding agent in an appropriate solvent to prepare a coating liquid. Subsequently, the coating liquid is applied onto the substrate or onto the first light-reflective layer 18 as described later on to form a coating film, and then dried. In this embodiment, the first write-once type recording layer 14 may be a single layer or a multilayer. In the case of the multilayer structure, the step of applying the coating liquid is performed more than one.

The concentration of the dye in the coating liquid is generally within a range of 0.01 to 15% by mass, preferably within a range of 0.1 to 10% by mass, more preferably within a range of 0.5 to 5% by mass, and most preferably within a range of 0.5 to 3% by mass.

Examples of the solvent of the coating liquid include esters such as butyl acetate, ethyl lactate, and cellosolve acetate; ketones such as methyl ethyl ketone, cyclohexanone, and methyl isobutyl ketone; chlorinated hydrocarbons such as dichloromethane, 1,2-dichloroethane, and chloroform; amides such as dimethylformamide; hydrocarbons such as methylcyclohexane; ethers such as tetrahydrofuran, ethyl ether, and dioxane; alcohols such as ethanol, n-propanol, isopropanol, n-butanol, and diacetone alcohol; fluorine-based solvents such as 2,2,3,3-tetrafluoropropanol; and glycol ethers such as ethylene glycol monomethyl ether, ethylene glycol monoethyl ether, and propylene glycol monomethyl ether.

The solvent as described above may be used singly, or in combination in consideration of the solubility of the dye to be used. Further, various additives including, for example, antioxidants, UV-absorbing agents, plasticizers, and lubricants may be added into the coating liquid depending on the purpose.

Examples of the coating method include the spray method, the spin coat method, the dip method, the roll coat method, the blade coat method, the doctor roll method, and the screen printing method.

When the coating is performed, the temperature of the coating liquid is preferably within a range of 23 to 50° C., more preferably within a range of 24 to 40° C.

The thickness of the first write-once type recording layer 14 formed as described above is preferably not more than 300 nm on the groove 38 (convex portion on the first substrate 12), more preferably not more than 250 nm, much more preferably not more than 200 nm, and especially preferably not more than 180 nm. The lower limit value is preferably not less than 30 nm, more preferably not less than 50 nm, much more preferably not less than 70 nm, and especially preferably not less than 90 nm.

The thickness of the first write-once type recording layer 14 on the land 40 (concave portion on the first substrate 12) is preferably not more than 400 nm, more preferably not more than 300 nm, and much more preferably not more than 250 nm. The lower limit value is preferably not less than 70 nm, more preferably not less than 90 nm, and much more preferably not less than 110 nm.

The ratio (t1/t2) between the thickness t1 of the first write-once type recording layer 14 on the groove 38 and the thickness t2 of the first write-once type recording layer 14 on the land 40 is preferably not less than 0.4, more preferably not less than 0.5, much more preferably not less than 0.6, and especially preferably not less than 0.7. The upper limit value is preferably less than 1, more preferably not more than 0.9, much more preferably not more than 0.85, and especially preferably not more than 0.8.

When the coating liquid contains the binding agent, examples of the binding agent include natural organic high molecular weight substances including, for example, gelatin, cellulose derivatives, dextran, rosin, and rubber; and synthetic organic high molecular weight substances including, for example, hydrocarbon-based resins such as polyethylene, polypropylene, polystyrene, and polyisobutylene, vinyl-based resins such as polyvinyl chloride, polyvinylidene chloride, and polyvinyl chloride-polyvinyl acetate copolymer, acrylic resins such as polymethyl acrylate and polymethyl methacrylate, polyvinyl alcohol, chlorinated polyethylene, epoxy resin, butylal resin, rubber derivative, and initial condensate of thermosetting resin such as phenol-formaldehyde resin. When the binding agent is used as the material for the first write-once type recording layer 14 in combination, the amount of use of the binding agent is generally within a range of 0.01 to 50 times of the dye by mass ratio, preferably within a range of 0.1 to 5 times by mass ratio.

The first write-once type recording layer 14 may contain various antifading agents in order to improve the light resistance of the first write-once type recording layer 14. A singlet oxygen quencher is generally used as the antifading agent. Those known from patent document publications can be used as the singlet oxygen quencher.

Specified examples thereof include those described in Japanese Laid-Open Patent Publication Nos. 58-175693, 59-81194, 60-18387, 60-19586, 60-19587, 60-35054, 60-36190, 60-36191, 60-44554, 60-44555, 60-44389, 60-44390, 60-54892, 60-47069, 63-209995, 4-25492, and Japanese Patent Publication Nos. 1-38680 and 6-26028 respectively as well as German Patent No. 350399, and Nippon Kagaku Kaishi, p. 1141, October, 1992.

The amount of use of the antifading agent such as the singlet oxygen quencher is usually within a range of 0.1 to 50% by mass, preferably within a range of 0.5 to 45% by mass, more preferably within a range of 3 to 40% by mass, and especially preferably within a range of 5 to 25% by mass with respect to the amount of the dye.

### Cover Layer 16 of First Optical Information-Recording Medium 10A

The cover layer 16 of the preferred first optical information-recording medium 10A is stuck onto the first write-once type recording layer 14 described above or the barrier layer 20 described later on by the first adhesive layer 22 composed of, for example, an adhesive or a sticking agent.

The cover layer 16 to be used for the first optical information-recording medium 10A is not specifically limited as far as it is transparent. However, it is preferable to use, for example, acrylic resin such as polycarbonate and polymethyl methacrylate; vinyl chloride-based resin such as polyvinyl chloride and vinyl chloride copolymer, epoxy resin; amorphous polyolefin; polyester; and cellulose triacetate. In particular, it is more preferable to use polycarbonate or cellulose triacetate.

The term “transparent” means the fact that the transmittance is not less than 80% with respect to the light to be used for the recording and reproduction.

Various additives may be contained in the cover layer 16 within a range in which the effect of the present invention is not inhibited. For example, it is also allowable to contain a UV-absorbing agent for cutting the light having a wavelength of not more than 400 nm, and/or a dye for cutting the light having a wavelength of not less than 500 nm.

As for the surface physical properties of the cover layer 16, it is preferable that both of the two-dimensional roughness parameter and the three-dimensional roughness parameter are not more than 5 nm in relation to the surface roughness.

It is preferable that the birefringence of the cover layer 16 is not more than 10 nm in view of the light-focusing degree of the light to be used for the recording and reproduction.

The thickness of the cover layer 16 is appropriately prescribed depending on the wavelength of the laser beam radiated for the recording and reproduction and NA of the first objective lens 42. However, the thickness of the cover layer 16 is within a range of 0.01 to 0.5 mm, more preferably, within a range of 0.05 to 0.12 mm in the first optical information-recording medium 10A.

The total thickness of the cover layer 16 and the adhesive layer 22 in combination is preferably 0.09 to 0.11 mm, and more preferably 0.095 to 0.105 mm.

A hard coat layer 44 (protective layer) may be provided on the light-incoming surface of the cover layer 16 in order to avoid any scratch on the light-incoming surface during the production of the first optical information-recording medium 10A.

As for the adhesive to be used for the adhesive layer 22, it is preferable to use, for example, UV-curable resin, EB-curable resin, and thermosetting resin. It is especially preferable to use UV-curable resin.

When the UV-curable resin is used as the adhesive, then the UV-curable resin may be used as it is, or the UV-curable resin may be dissolved in an appropriate solvent such as methyl ethyl ketone or ethyl acetate to prepare a coating liquid, which may be supplied from a dispenser to the surface of the barrier layer 20. In order to avoid warpage of the first optical information-recording medium 10A to be manufactured, it is preferable that the UV-curable resin for forming the adhesive layer 22 has a small coefficient of curing contraction. Such-a UV-curable resin may include, for example, UV-curable resins such as “SD-640” available from DAINIPPON INK AND CHEMICALS, INCORPORATED.

The adhesive is preferably used as follows: a predetermined amount of the adhesive is applied onto the objective sticking surface composed of the barrier layer 20. After the cover layer 16 is placed thereon, the adhesive is spread by spin coating so that it is uniformly spread between the objective sticking surface and the cover layer 16, and then cured.

The thickness of the adhesive layer 22 composed of the adhesive as described above is preferably within a range of 0.1 to 100 μm, more preferably within a range of 0.5 to 50 μm, and much more preferably within a range of 10 to 30 μm.

Acrylic, rubber-based, and silicon-based adhesives may be used as the sticking agent for the adhesive layer 22. It is preferable to use the acrylic sticking agent in view of the transparency and the durability. Those preferably usable as the acrylic sticking agent as described above contain the main component of, for example, 2-ethylhexyl acrylate or n-butyl acrylate. In order to improve cohesion, the main component may be copolymerized with short chain alkyl acrylate or methacrylate, such as methyl acrylate, ethyl acrylate, or methyl methacrylate, and acrylic acid, methacrylic acid, acrylamide derivative, maleic acid, hydroxyethyl acrylate, glycidyl acrylate or the like each capable of serving as the crosslinking point with the crosslinking agent. The glass transition temperature (Tg) and the crosslinking density can be changed appropriately in the type and the mixing ratio of the main component, the short chain component, and the component to add the crosslinking point.

Examples of the crosslinking agent, which is used in combination with the sticking agent as described above, include isocyanate-based crosslinking agents. Those usable as the isocyanate-based crosslinking agent may include isocyanates such as tolylenediisocyanate, 4,4′-diphenylmethane diisocyanate, hexamethylene diisocyanate, xylylene diisocyanate, naphthylene-1,5-diisocyanate, o-toluidine isocyanate, isophorone diisocyanate, and triphenylmethane triisocyanate, products of isocyanates and polyalcohols, and polyisocyanates produced by condensation of isocyanates. Commercially available products of isocyanates as described above may include, for example, CORONATE L, CORONATE HL, CORONATE 2030, CORONATE 2031, MILLIONATE MR, and MILLIONATE HTL available from NIPPON POLYURETHANE CO., LTD.; TAKENATE D-102, TAKENATE D-110N, TAKENATE D-200, and TAKENATE D-202 available from TAKEDA; and Desmodule L, Desmodule IL, Desmodule N, and Desmodule HL available from Sumitomo-Bayer.

A predetermined amount of the sticking agent may be applied uniformly onto the objective sticking surface composed of the barrier layer 20. The cover layer 16 may be placed thereon, and then the sticking agent is cured. Alternatively, a predetermined amount of the sticking agent may be previously applied uniformly onto one surface of the cover layer 16 to form a coating film of the sticking agent. The coating film may be stuck to the objective sticking surface, and then the sticking agent is cured.

A commercially available adhesive film previously provided with a sticking agent layer in advance may be used for the cover layer 16.

The thickness of the adhesive layer 22 composed of the sticking agent as described above is preferably within a range of 0.1 to 100 μm, more preferably within a range of 0.5 to 50 μm, and much more preferably within a range of 10 to 30 μm.

### Other Layers of First Optical Information-Recording Medium 10A

The preferred first optical information-recording medium 10A may have other arbitrary layer in addition to the essential layers described above within a range in which the effect of the present invention is not deteriorated. The other arbitrary layer includes, for example, a label layer which has a desired image and which is formed on the back surface of the first substrate 12 (back surface with respect to the surface of formation of the first write-once type recording layer 14), the first light-reflective layer 18 (described later on) which is provided between the first substrate 12 and the first write-once type recording layer 14, the barrier layer 20 (described later on) which is provided between the first write-once type recording layer 14 and the cover layer 16, and an interface layer which is provided between the first light-reflective layer 18 and the first write-once type recording layer 14. In this embodiment, the label layer is formed by using, for example, an ultraviolet-curable resin, a thermosetting resin, and a thermal drying resin.

Any one of the essential and arbitrary layers may be a single layer, or have a multilayer structure.

### First Light-Reflective Layer 18 of First Optical Information-Recording Medium 10A

It is preferable to form the first light-reflective layer 18 between the first substrate 12 and the first write-once type recording layer 14 in order to enhance the reflectance with respect to the laser beam and/or add the function to improve the recording and reproduction characteristics in the first optical information-recording medium 10A.

As for the first light-reflective layer 18, a light-reflective substance, which has a high reflectance with respect to the laser beam, can be formed on the substrate by vacuum vapor deposition, sputtering, or ion plating.

The layer thickness of the first light-reflective layer 18 is generally within a range of 10 to 300 nm, and preferably within a range of 50 to 200 nm.

The reflectance is preferably not less than 70%.

The light-reflective substance having the high reflectance may include stainless steel, half metal or metal such as Mg, Se, Y, Ti, Zr, Hf, V, Nb, Ta, Cr, Mo, W, Mn, Re, Fe, Co, Ni, Ru, Rh, Pd, Ir, Pt, Cu, Ag, Au, Zn, Cd, Al, Ga, In, Si, Ge, Te, Pb, Po, Sn, and Bi. The light-reflective substance as described above may be used singly, in combination, or as an alloy. In particular, it is preferable to use Cr, Ni, Pt, Cu, Ag, Au, Al, and stainless steel. It is especially preferable to use Au, Ag, Al, or an alloy thereof, and most preferable to use Au, Ag, or an alloy thereof.

### Barrier Layer 20 (Intermediate Layer) of First Optical Information-Recording Medium 10A

It is preferable to form the barrier layer 20 between the first write-once type recording layer 14 and the cover layer 16 in the first optical information-recording medium 10A.

The barrier layer 20 is provided, for example, in order that the first write-once type recording layer 14 keeps a high quality adhesion between the first write-once type recording layer 14 and the cover layer 16, the reflectance is adjusted, and the coefficient of thermal conductivity is adjusted.

The material to be used for the barrier layer 20 is not specifically limited as far as the light beam to be used for the recording and reproduction is transmitted through the material, and the material can express the function as described above. Examples of the material generally include materials having a low permeability of gas and water, and being a dielectric.

Specifically, the material is preferably composed of nitride, oxide, carbide, or sulfide of, for example, Zn, Si, Ti, Te, Sn, Mo, and Ge. It is preferable to use ZnS, MoO₂, GeO₂, TeO, SiO₂, TiO₂, ZuO, ZnS—SiO₂, SnO₂, and ZnO—Ga₂O₃. It is more preferable to use ZnS—SiO₂, SnO₂, and ZnO—Ga₂O₃.

The barrier layer 20 can be formed by means of the vacuum film formation method including, for example, the vacuum vapor deposition, the DC sputtering, the RF sputtering, and the ion plating. In particular, it is more preferable to use the sputtering, and much more preferable to use the RF sputtering.

The thickness of the barrier layer 20 is preferably within a range of 1 to 200 nm, more preferably within a range of 2 to 100 nm, and much more preferably within a range of 3 to 50 nm.

Next, the second optical information-recording medium 10B will be explained with reference to FIG. 4.

The second optical information-recording medium 10B is the optical information-recording medium having the sticking type layer structure. The representative layer structures are as follows.

(1) As shown in FIG. 4, the first layer structure is constructed such that a second write-once type recording layer 26, a second light-reflective layer 30, and a second adhesive layer 32 are successively formed on a second substrate 24, and a protective substrate 28 is provided on the second adhesive layer 32.

(2) Although not shown, the second layer structure is constructed such that a second write-once type recording layer 26, a second light-reflective layer 30, a protective layer, and a second adhesive layer 32 are successively formed on a second substrate 24, and a protective substrate 28 is provided on the second adhesive layer 32.

(3) Although not shown, the third layer structure is constructed such that a second write-once type recording layer 26, a second light-reflective layer 30, a protective layer, a second adhesive layer 32, and a protective layer are successively formed on a second substrate 24, and a protective substrate 28 is provided on the protective layer.

(4) Although not shown, the fourth layer structure is constructed such that a second write-once type recording layer 26, a second light-reflective layer 30, a protective layer, a second adhesive layer 32, a protective layer, and a light-reflective layer are successively formed on a second substrate 24, and a protective substrate 28 is provided on the light-reflective layer.

(5) Although not shown, the fifth layer structure is constructed such that a second write-once type recording layer 26, a second light-reflective layer 30, a second adhesive layer 32, and a light-reflective layer are successively formed on a second substrate 24, and a protective substrate 28 is provided on the light-reflective layer.

The layer structures (1) to (5) are mere examples, and the order of the layers described above may be replaced or omitted in part. The second write-once type recording layer 26 may also be formed on the side of the protective substrate 28. In this case, the recording and reproduction can be performed on the both surfaces of the optical information-recording medium. Further, each of the layers may be composed of a single layer or a plurality of layers.

The second optical information-recording medium 10B will now be explained below as exemplified by the structure having the second write-once type recording layer 26, the second light-reflective layer 30, the second adhesive layer 32, and the protective substrate 28 in this order on the second substrate 24 as shown in FIG. 4.

### Second Substrate 24 of Second Optical Information-Recording Medium 10B

It is essential that the second pregroove 36 (guide groove), which has such a shape that all of the track pitch, the groove width (half value of width), the groove depth, and the wobble amplitude are within the following ranges, is formed on the second substrate 24 of the second optical information-recording medium 10B. The second pregroove 36 is provided in order to achieve the recording density higher than those of CD-Rs and DVD-Rs. High recording density is preferred, for example, when the second optical information-recording medium 10B is used as a medium adapted to the blue-violet laser.

It is appropriate that the track pitch of the second pregroove 36 is within a range of 200 to 600 nm. The upper limit value is preferably not more than 500 nm, more preferably not more than 450 nm, and much more preferably not more than 430 nm. The lower limit value is preferably not less than 300 nm, more preferably not less than 330 nm, and much more preferably not less than 370 nm.

If the track pitch is less than 200 nm, it is difficult to form the second pregroove 36 correctly. Further, the crosstalk tends to arise. If the track pitch exceeds 600 nm, the recording density is lowered.

It is appropriate that the groove width (half value of width) of the second pregroove 36 is within a range of 50 to 300 nm. The upper limit value is preferably not more than 250 nm, more preferably not more than 200 nm, and much more preferably not more than 180 nm. The lower limit value is preferably not less than 100 nm, more preferably not less than 120 nm, and much more preferably not less than 140 nm.

If the groove width of the second pregroove 36 is less than 50 nm, then the groove is not transferred sufficiently during the formation in some cases, and the error rate is raised during the recording in other cases. If the groove width exceeds 300 nm, the pit formed upon the recording is consequently widened. The crosstalk is caused in some cases, and sufficient modulation degree is not obtained in other cases.

It is appropriate that the groove depth of the second pregroove 36 is within a range of 30 to 200 nm. The upper limit value is preferably not more than 170 nm, more preferably not more than 140 nm, and much more preferably not more than 120 nm. The lower limit value is preferably not less than 40 nm, more preferably not less than 50 nm, and much more preferably not less than 60 nm.

If the groove depth of the second pregroove 36 is less than 30 nm, sufficient recording modulation degree may not be obtained. If the groove depth exceeds 200 nm, the reflectance may be greatly lowered.

Various materials having been used as the substrate material for conventional optical information-recording medium can be arbitrarily used for the second substrate 24 for the second optical information-recording medium 10B. Specified examples and preferred examples are the same as or equivalent to those for the first substrate 12 of the first optical information-recording medium 10A.

It is appropriate that the thickness of the second substrate 24 is within a range of 0.1 to 1.0 mm. The thickness is preferably within a range of 0.2 to 0.8 mm, and more preferably within a range of 0.3 to 0.7 mm.

It is preferable that an undercoat layer is formed on the surface of the second substrate 24 on the side on which the second write-once type recording layer 26 is provided as described later on in order to impart flatness and improve adhesive force. Specified examples and preferred examples of the material for the undercoat layer, the coating method, and the layer thickness are the same as or equivalent to those for the undercoat layer of the first optical information-recording medium 10A.

### Second Write-Once Type Recording Layer 26 of Second Optical Information-Recording Medium 10B

Detailed description about the second write-once type recording layer 26 of the preferred second optical information-recording medium 10B is the same as or equivalent to that about the first write-once type recording layer 14 of the first optical information-recording medium 10A.

### Second Light-Reflective Layer 30 of Second Optical Information-Recording Medium 10B

The second light-reflective layer 30 may be formed on the second write-once type recording layer 26 in order to enhance the reflectance with respect to the laser beam and/or add the function to improve the recording and reproduction characteristics in the second optical information-recording medium 10B. Details of the second light-reflective layer 30 of the second optical information-recording medium 10B are the same as or equivalent to those of the first light-reflective layer 18 of the first optical information-recording medium 10A.

### Second Adhesive Layer 32 of Second Optical Information-Recording Medium 10B

The second adhesive layer 32 of the preferred second optical information-recording medium 10B is an arbitrary layer formed to improve the tight contact performance between the second light-reflective layer 30 and the protective substrate 28.

A photocurable resin is preferable as the material for the second adhesive layer 32. In particular, in order to avoid warpage of the disk, it is preferable that the material has a small coefficient of curing contraction. Such a photocurable resin may include, for example, UV-curable resins (UV-curable adhesives) such as “SD-640” and “SD-347” available from DAINIPPON INK AND CHEMICALS, INCORPORATED. It is preferable that the thickness of the second adhesive layer 32 is within a range of 1 to 1,000 μm in order to provide the elasticity or resilience.

### Protective Substrate 28 of Second Optical Information-Recording Medium 10B

A substrate, which is the same in the material and the shape as those of the second substrate 24 described above, can be used for the protective substrate 28 (dummy substrate) of the preferred second optical information-recording medium 10B. It is necessary that the thickness of the protective substrate 28 is within a range of 0.1 to 1.0 mm. The thickness is preferably within a range of 0.2 to 0.8 mm, and more preferably within a range of 0.3 to 0.7 mm.

### Protective Layer (Not Shown) of Second Optical Information-Recording Medium 10B

The second optical information-recording medium 10B is sometimes provided with the protective layer in order to physically and chemically protect, for example, the second light-reflective layer 30 and the second write-once type recording layer 26 depending on the layer structure.

Examples of the material to be used for the protective layer include inorganic substances such as ZnS, ZnS—SiO₂, SiO, SiO₂, MgF₂, SnO₂, and Si₃N₄, and organic substances such as thermoplastic resins, thermosetting resins, and UV-curable resins.

The protective layer can be formed, for example, such that a film, which is obtained by the extrusion processing of plastic, is stuck onto the light-reflective layer by an adhesive. Alternatively, the protective layer may be provided by the method including, for example, the vacuum vapor deposition, the sputtering, and the coating.

When the thermoplastic resin or the thermosetting resin is used for the protective layer, the protective layer can also be formed such that a coating liquid is prepared by dissolving the rein in an appropriate solvent. Next, the coating liquid is applied, and then dried. In the case of the UV-curable resin, the protective layer can also be formed such that a coating liquid is prepared by using the resin as it is or by dissolving the resin in an appropriate solvent, and thus prepared coating liquid is applied, and then cured by radiating the UV light. Various additives such as an antistatic agent, an antioxidant, and a UV-absorbing agent may be added to the coating liquid depending on the purpose. The layer thickness of the protective layer is generally within a range of 0.1 μm to 1 mm.

### Other Layers of Second Optical Information-Recording Medium 10B

The second optical information-recording medium 10B may have other arbitrary layer in addition to the layers described above within a range in which the effect of the present invention is not deteriorated. Detailed description about the other arbitrary layers is the same as or equivalent to that for the other layers of the first optical information-recording medium 10A.

### Optical Information-Recording Method

The optical information-recording method of the present invention is performed, for example, as follows by using the first optical information-recording medium 10A or the second optical information-recording medium 10B.

When the first optical information-recording medium 10A is used, the recording laser beam 46 such as the semiconductor laser beam is firstly radiated from the side of the cover layer 16 via the first objective lens 42 having a numerical aperture NA of, for example, 0.85, while rotating the first optical information-recording medium 10A at a constant linear velocity (0.5 to 10 m/second) or a constant angular velocity. It is assumed that when the radiation of the laser beam 46 locally raises temperature of the first write-once type recording layer 14 due to absorption of the laser beam 46, the physical or chemical change (for example, the pit formation) is caused so that the optical characteristics are changed, resulting in information recording.

Similarly, when the second optical information-recording medium 10B is used, the recording laser beam 46 such as the semiconductor laser beam is firstly radiated from the side of the second substrate 24 via the second objective lens 48 having a numerical aperture NA of, for example, 0.65, while rotating the second optical information-recording medium 10B at a constant linear velocity (0.5 to 10 m/second) or a constant angular velocity. It is assumed that when the radiation of the laser beam 46 locally raises temperature of the second write-once type recording layer 26 due to absorption of the laser beam 46, the physical or chemical change (for example, the pit formation) is caused so that change the optical characteristics are changed, resulting in information recording.

In the embodiment of the present invention, the semiconductor laser beam, which has the emission wavelength within a range of 390 to 450 nm, is used as the recording laser beam 46. The light source may preferably include the blue-violet semiconductor laser beam having an emission wavelength within a range of 390 to 415 nm, and the blue-violet SHG laser beam having a center emission wavelength of 425 nm in which the wavelength is made half using an optical waveguide element for the infrared semiconductor laser beam having a center emission wavelength of 850 nm. In particular, it is preferable to use the blue-violet semiconductor laser beam having an emission wavelength within a range of 390 to 415 nm in view of the recording density. The information, which has been recorded as described above, can be reproduced such that the semiconductor laser beam is radiated from the side of the substrate or the side of the protective layer, and the reflected light beam is detected, while rotating the first optical information-recording medium at the same constant linear velocity as that described above.

### Synthesis of Compounds

The azo dye, which serves as the ligand of the metal complex of the present invention, can be synthesized by the general synthesizing method for the azo dye. The azo dye can be synthesized, for example, by a synthesis method described in Japanese Laid-Open Patent Publication No. 63-202666.

Examples of the synthesis of the compounds of the present invention are described below. The other compounds of the present invention can also be synthesized by a similar process.

### SYNTHESIS EXAMPLE 1

### Synthesis of Proton Adduct of Ligand (I-1a)

The compound of the proton adduct of the ligand (I-1a) was synthesized in accordance with the following scheme.

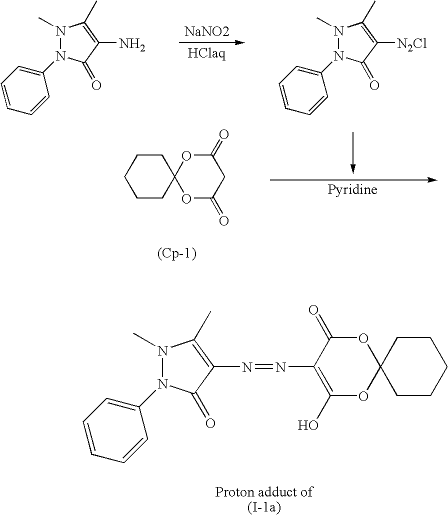

2.1 g of 4-aminoantipyrine was dissolved in 16 ml of 2N hydrochloric acid, and 2 ml of aqueous solution containing 0.72 g of sodium nitrite was dropped thereinto while being cooled with ice. An obtained diazonium salt solution was added to 30 ml of pyridine solution containing 1.8 g of (Cp-1) while being cooled with ice. The temperature was then raised to a room temperature while being stirred. Produced crystals were filtrated, and then washed with water to obtain 3.1 g of proton adduct of (I-1a). The structure was confirmed by NMR.

¹H NMR (DMSO-d6): δ=1.5 (m, 2H), 1.7 to 1.8 (m, 4H), 2.0 (t, 4H), 2.6 (s, 3H), 3.2 (s, 3H), 7.3 to 7.6 (m, 5H).

### SYNTHESIS EXAMPLE 2

### Synthesis of Proton Adduct of Ligand (I-5a)

The proton adduct of the ligand (I-5a) was synthesized in accordance with the following scheme.

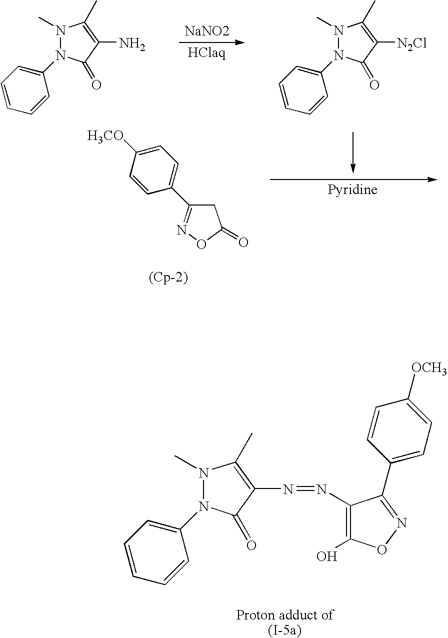

2.1 g of 4-aminoantipyrine was dissolved in 16 ml of 2N hydrochloric acid, and 2 ml of aqueous solution containing 0.72 g of sodium nitrite was dropped thereinto, while being cooled with ice. An obtained diazonium salt solution was added to 30 ml of pyridine solution containing 1.9 g of (Cp-2) while being cooled with ice. The temperature was raised to a room temperature while being stirred. Dilute hydrochloric acid was added. Produced crystals were filtrated, and then washed with water to obtain 3.4 g of proton adduct of (I-5a). The structure was confirmed by NMR.

¹H NMR (DMSO-d6): δ=2.5 (s, 3H), 3.2 (s, 3H), 3.8 (s, 3H), 7.1 (dd, 2H), 7.4 (m, 3H), 7.5 to 7.6 (m, 2H), 7.9 to 8.0 (dd, 2H).

### SYNTHESIS EXAMPLE 3

### Synthesis of Metal Complex (S-1a)

0.5 g of the proton adduct of the ligand (I-1a) and 0.11 g of sodium acetate are added to 12 ml of ethanol, and 3 ml of aqueous solution containing 0.12 g of copper acetate was dropped thereinto while being heated and refluxed. Thus obtained solution was then left to be cooled to a room temperature. Produced crystals were filtrated, and then washed with water to obtain 0.38 g of metal complex (S-1a).

Solution absorption maximum (acetonitrile)=405 nm.

### SYNTHESIS EXAMPLE 4

### Synthesis of Metal Complex (S-5a)

0.5 g of the proton adduct of the ligand (I-5a) and 0.11 g of sodium acetate were added to 15 ml of ethanol, and 3 ml of aqueous solution containing 0.15 g of nickel acetate was dropped thereinto while being heated and refluxed. Thus obtained solution was left to be cooled to a room temperature. Produced crystals were filtrated, and then washed with water to obtain 0.50 g of metal complex (S-5a).

Solution absorption maximum (acetonitrile)=433 nm.

### SYNTHESIS EXAMPLE 5

### Synthesis of Proton Adduct of Ligand (I-1b)

The compound of the proton adduct of the ligand (I-1b) was synthesized in accordance with the following scheme.

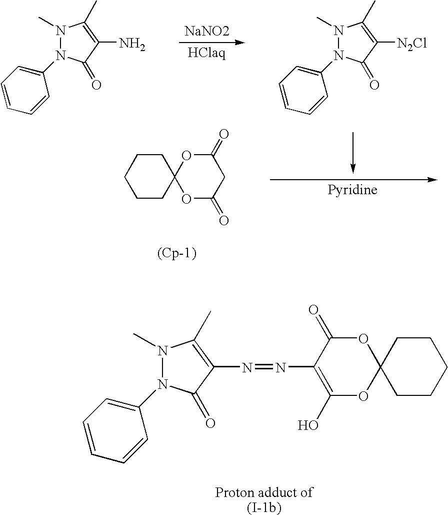

2.1 g of 4-aminoantipyrine was dissolved in 16 ml of 2N hydrochloric acid, and 2 ml of aqueous solution containing 0.72 g of sodium nitrite was dropped thereinto while being cooled with ice. An obtained diazonium salt solution was added to 30 ml of pyridine solution containing 1.8 g of (Cp-1) while being cooled with ice. The temperature was raised to a room temperature while being stirred. Produced crystals were filtrated, and then washed with water to obtain 2.5 g of proton adduct of (I-1b). The structure was confirmed by NMR.

¹H NMR (DMSO-d6): δ=2.5 (s, 3H), 3.2 (s, 3H), 7.3 to 7.4 (m, 3H), 7.5 to 7.6 (m, 2H), 7.6 to 7.8 (m, 4H), 8.6 (s, 1H).

### SYNTHESIS EXAMPLE 6

### Synthesis of Proton Adduct of Ligand (I-2b)

The proton adduct of the ligand (I-2b) was synthesized in accordance with the following scheme.

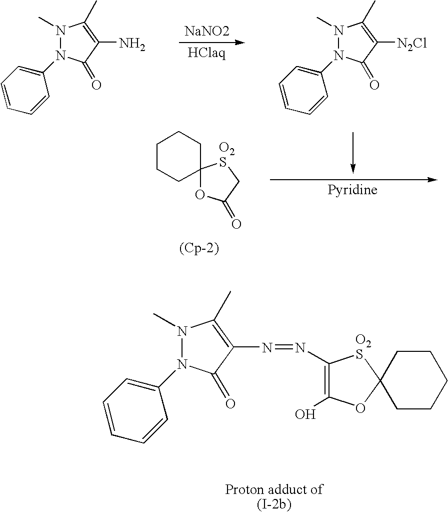

2.1 g of 4-aminoantipyrine was dissolved in 16 ml of 2N hydrochloric acid, and 2 ml of aqueous solution containing 0.72 g of sodium nitrite is dropped thereinto while being cooled with ice. An obtained diazonium salt solution is added to 30 ml of pyridine solution containing 2.0 g of (Cp-2) while being cooled with ice. The temperature was raised to a room temperature while being stirred. Dilute hydrochloric acid was added. Produced crystals were filtrated, and then washed with water to obtain 2.9 g of proton adduct of (I-2b). The structure was confirmed by NMR.

¹H NMR (DMSO-d6): δ=1.4 (m, 1H), 1.5 to 1.8 (m, 5H), 2.0 (m, 4H), 2.4 (s, 3H), 3.2 (s, 3H), 7.3 to 7.4 (m, 3H), 7.5 to 7.6 (m, 2H).

### SYNTHESIS EXAMPLE 7

### Synthesis of Metal Complex (S-1b)

0.5 g of the proton adduct of the ligand (I-1b) and 0.11 g of sodium acetate were added to 12 ml of ethanol, and 3 ml of aqueous solution containing 0.12 g of copper acetate was dropped thereinto while being heated and refluxed. The obtained solution was left to be cooled to a room temperature. Produced crystals were filtrated, and then washed with water to obtain 0.47 g of metal complex (S-1b).

Solution absorption maximum (acetonitrile)=454 nm.

### SYNTHESIS EXAMPLE 8

### Synthesis of Metal Complex (S-5b)

0.5 g of the proton adduct of the ligand (I-2b) and 0.10 g of sodium acetate were added to 12 ml of ethanol, and 3 ml of aqueous solution containing 0.15 g of nickel acetate was dropped thereinto while being heated and refluxed. The obtained solution was left to be cooled to a room temperature. Produced crystals were filtrated, and then washed with water to obtain 0.50 g of metal complex (S-5b).

Solution absorption maximum (acetonitrile)=388 nm.

Examples of the present invention are described below.

### EXAMPLES 1 TO 5, EXAMPLES 11 TO 15

### Production of Optical Information-Recording Medium (First Optical Information-Recording Medium 10A)

### Manufacturing of First Substrate 12:

An injection molded substrate (first substrate 12) composed of polycarbonate resin was manufactured, which had a thickness of 1.1 mm, an outer diameter of 120 mm, and an inner diameter of 15 mm and a spiral-shaped first pregroove 34 (track pitch: 320 nm, groove width: 120 nm at the bottom of the groove, groove depth: 35 nm, groove inclination angle: 65°, wobble amplitude: 20 nm). Mastering of a stamper used for injection molding was performed by using the laser cutting (351 nm).

### Formation of First Light-Reflective Layer 18:

An APC light-reflective layer (Ag: 98.1% by mass, Pd: 0.9% by mass, Cu: 1.0% by mass) was formed as a vacuum film formation layer having a film thickness of 100 nm on the first substrate 12 by the DC sputtering under an Ar atmosphere by using Cube available from Unaxis. The film thickness of the first light-reflective layer 18 was adjusted by depending on the sputtering time.

### Formation of First Write-Once Type Recording Layer 14:

2 g of each of the compounds (S-1a), (S-2a), (S-3a), (S-5a), and (S-10a) shown in FIG. 1 or each of the compounds (S-1b), (S-2b), (S-3b), (S-5b), and (S-11b) shown in FIG. 2 was individually added and dissolved in 100 ml of 2,2,3,3-tetrafluoropropanol to prepare a dye-containing coating liquid. The first light-reflective layer 18 was coated with the prepared dye-containing coating liquid by the spin coating method under a condition of 23° C. and 50% RH while changing the number of revolutions from 300 to 4,000 rpm. After that, the contents were stored for 1 hour at 23° C. and 50% RH to form a first write-once type recording layer 14 (thickness on the groove 38: 120 nm, thickness on the land 40: 170 nm).

After forming the first write-once type recording layer 14, an annealing treatment was applied in a clean oven. The first substrate 12 was supported with a perpendicular stack pole while providing a space with a spacer for 1 hour at 80° C. for annealing treatment.

### Formation of Barrier Layer 20:

Subsequently, a barrier layer 20 having a thickness of 5 nm, which was composed of ZnO—Ga₂O₃ (ZnO:Ga₂O₃=7:3 (mass ratio)), was formed on the first write-once type recording layer 14 by the RF sputtering under an Ar atmosphere by using Cube available from Unaxis.

### Sticking of Cover Layer 16:

A film made of polycarbonate (PURE-ACE available from Teijin, thickness: 80 μm), which had an inner diameter of 15 mm and an outer diameter of 120 mm and which included an adhesive applied onto one surface, was used as a cover layer 16. The total thickness of the adhesive layer (first adhesive layer 22) and the film made of polycarbonate (cover layer 16) was set to 100 μm.

The cover layer 16 was placed on the barrier layer 20 so that the barrier layer 20 abutted against the adhesive layer (first adhesive layer 22). Then, the cover layer 16 was stuck to the barrier layer 20 by making contact under pressure by a pushing abutment member.

### COMPARATIVE EXAMPLES 1 AND 2

A first optical information-recording medium 10A was manufactured in accordance with the same method as that of Example 1 except that the following comparative compound (A) or (B) was used in place of the compound (S-1a).

Comparative compound A (Specified Example (b) described in Japanese Laid-Open Patent Publication No. 11-58758):

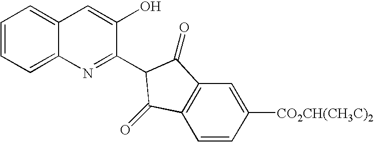

Comparative compound B (Specified Example (c) described in Japanese Laid-Open Patent Publication No. 11-58758):

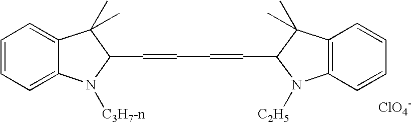

Accordingly, the first optical information-recording medium 10A of Examples 1 to 5, Examples 11 to 15, and Comparative Examples 1 and 2 were manufactured.

### Evaluation of Optical Information-Recording Medium (First Optical Information-Recording Medium 10A)

### Evaluation of C/N (Carrier-to-Noise Ratio):

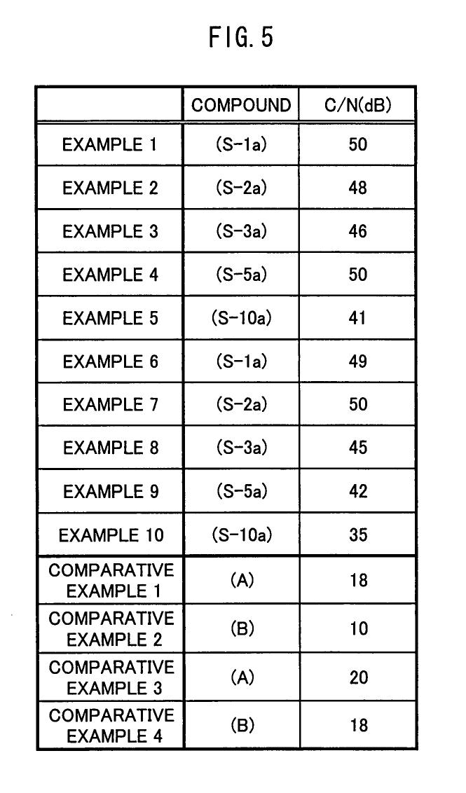

A signal (2T) of 0.16 μm was recorded and reproduced on the manufactured first optical information-recording medium 10A at a clock frequency of 66 MHz and a linear velocity of 5.28 m/sec by using a recording and reproduction evaluating machine (DDU 1000 available from PulseTech) carried with a pickup for radiating a laser beam 46 of a wavelength of 405 nm and having a first objective lens 42 of NA=0.85. C/N (after the recording) was measured by using a spectrum analyzer (MSG 2 available from PulseTech). The recording was performed in the groove. The reflectance after recording was higher than that before recording in some cases and the former was lower than the latter in other cases depending on the relationship between the laser wavelength and the absorption wavelength of the recording dye used. However, the change ratio was read as C/N in relation to the ratio of the lower reflectance with respect to the higher reflectance. Obtained results are shown in FIG. 5.

### EXAMPLES 6 TO 10, EXAMPLES 16 TO 20

### Production of Optical Information-Recording Medium (Second Optical Information-Recording Medium 10B)

### Manufacturing of Second Substrate 24:

An injection molded substrate (second substrate 24) composed of polycarbonate resin was manufactured, which had a thickness of 0.6 mm, an outer diameter of 120 mm, and an inner diameter of 15 mm and which was provided with a spiral-shaped second pregroove 36 (track pitch: 400 nm, groove width: 170 nm, groove depth: 100 nm, groove inclination angle: 65°, wobble amplitude: 20 nm). The mastering of a stamper used for the injection molding was performed by using the laser cutting (351 nm).

### Formation of Second Write-Once Type Recording Layer 26:

2 g of each of the compounds (S-1a), (S-2a), (S-3a), (S-5a), and (S-10a) shown in FIG. 1 or each of the compounds (S-1b), (S-2b), (S-3b), (S-5b), and (S-11b) shown in FIG. 2 was individually added and dissolved in 100 ml of 2,2,3,3-tetrafluoropropanol to prepare a dye-containing coating liquid. The second substrate 24 was coated with the prepared dye-containing coating liquid by the spin coating method at 23° C. and 50% RH while changing the number of revolutions from 300 to 4,000 rpm. Then, the second substrate 24 was kept for 1 hour at 23° C. and 50% RH to have a second write-once type recording layer 26 (thickness on the groove 45: 170 nm, thickness on the land 47: 120 nm).

After forming the second write-once type recording layer 26, an annealing treatment was applied in a clean oven. The second substrate 24 was supported with a perpendicular stack pole for 1 hour at 80° C. while a space was provided with a spacer.

### Formation of Second Light-Reflective Layer 30:

An APC light-reflective layer (Ag: 98.1% by mass, Pd: 0.9% by mass, Cu: 1.0% by mass) was formed as a vacuum film formation layer having a film thickness of 100 nm on the second write-once type recording layer 26 by the DC sputtering under an Ar atmosphere by using Cube available from Unaxis. The film thickness of the second light-reflective layer 30 was adjusted depending on the sputtering time.

### Sticking of Protective Substrate 28:

Ultraviolet-curable resin (SD 661 available from DAINIPPON INK AND CHEMICALS, INCORPORATED) was applied onto the second light-reflective layer 30 by the spin coating. A protective substrate 28 made of polycarbonate (equivalent to the second substrate 24 except for the absence of the formation of the pregroove) was stuck, and the ultraviolet light was radiated to cure the ultraviolet curable resin.

The thickness of the second adhesive layer 32 composed of the ultraviolet-curable resin of the manufactured second optical information-recording medium 10B was 25 μm.

### COMPARATIVE EXAMPLES 3 AND 4

A second optical information-recording medium 10B was manufactured in accordance with the same method as that of Example 6 except that the foregoing comparative compound (A) or (B) was used in place of the compound (S-1a).

Accordingly, the second optical information-recording medium 10B of Examples 6 to 10, Examples 16 to 20, and Comparative Examples 3 and 4 were manufactured.

### Evaluation of Optical Information-Recording Medium (Second Optical Information-Recording Medium 10B)

### Evaluation of C/N (Carrier-to-Noise Ratio):

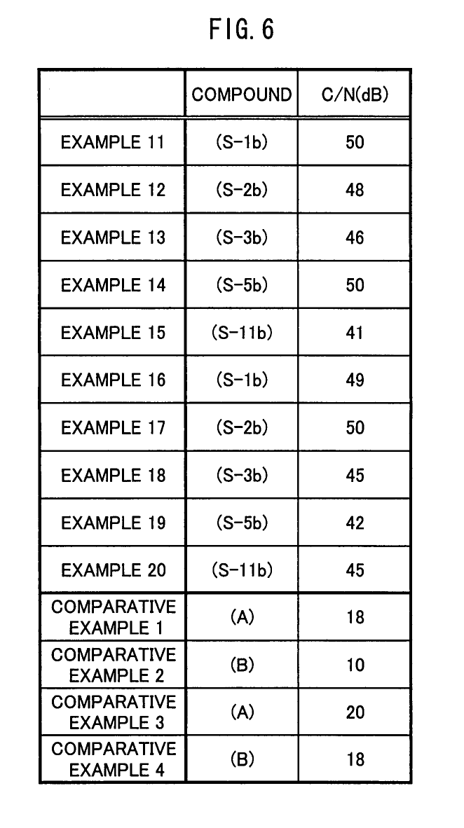

A signal (2T) of 0.2 μm was recorded and reproduced on the manufactured second optical information-recording medium 10B at a clock frequency of 64.8 MHz and a linear velocity of 6.6 m/sec by using a recording and reproduction evaluating machine (DDU 1000 available from PulseTech) carried with a pickup for radiating a laser beam 46 of a wavelength of 405 nm and having a second objective lens 48 of NA=0.65. C/N (after the recording) was measured by using a spectrum analyzer (MSG 2 available from PulseTech). The recording was performed in the groove. The reflectance after the recording was higher than that before the recording in some cases and the former was lower than the latter in other cases depending on the relationship between the laser wavelength and the absorption wavelength of the recording dye used. However, the change ratio was read as C/N in relation to the ratio of the lower reflectance with respect to the higher reflectance. Obtained results are shown in FIG. 6.

According to the results shown in FIGS. 5 and 6, it is clear that the first optical information-recording medium 10A (Examples 1 to 5 and 11 to 15) and the second optical information-recording medium 10B (Examples 6 to 10 and 16 to 20), which are composed of the recording layers containing the compounds of the present invention, make it possible to obtain the high reproduced signal intensity as compared with Comparative Examples 1 to 4.

The Xe light beam at 40,000 lux was radiated for 24 hours onto the first optical information-recording medium 10A concerning Examples 1 to 5 and 11 to 15, the second optical information-recording medium 10B concerning Examples 6 to 10 and 16 to 20, the first optical information-recording medium 10A concerning Comparative Examples 1 and 2, and the second optical information-recording medium 10B concerning Comparative Examples 3 and 4. Thereafter, all recording signal were successfully read by the first optical information-recording medium 10A concerning Examples 1 to 5 and 11 to 15 and the second optical information-recording medium 10B concerning Examples 6 to 10 and 16 to 20. On the contrary, it was impossible to read the recording signal by the first optical information-recording medium 10A concerning Comparative Examples 1 and 2 and the second optical information-recording medium 10B concerning Comparative Examples 3 and 4. According to this result, it is clear that the first optical information-recording medium 10A concerning Examples 1 to 5 and 11 to 15 and the second optical information-recording medium 10B concerning Examples 6 to 10 and 16 to 20 exhibit high light resistance as compared with the first optical information-recording medium 10A concerning Comparative Examples 1 and 2 and the second optical information-recording medium 10B concerning Comparative Examples 3 and 4.

The optical information-recording medium, the information-recording method, and the compound according to the present invention are not limited to the embodiments described above, and may be in other various forms without deviating from the gist or essential characteristics of the present invention.

Although certain preferred embodiments of the present invention have been shown and described in detail, it should be understood that various changes and modifications may be made therein without departing from the scope of the appended claims.

What is claimed is:

1. An optical information-recording medium having, on a substrate, a recording layer capable of recording information by being irradiated with a laser beam having a wavelength of not more than 440 nm, wherein:
said recording layer contains a metal complex having a ligand of a compound represented by the following general formula (I): 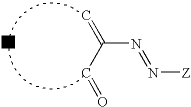
wherein Z represents: 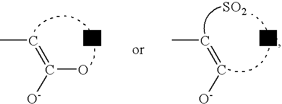
wherein each of X, Y¹, Y² independently represents an atom group forming a five-membered or six-membered heterocyclic ring which may be condensed.

2. The optical information-recording medium according to claim 1, wherein said five-membered or six-membered heterocyclic ring formed by the atom group represented by Y² in said general formula (I), which may be subjected to said ring condensation, contains no nitrogen atom.

3. The optical information-recording medium according to claim 1, wherein said ligand of said general formula (I) is a compound represented by the following general formula (IIa): 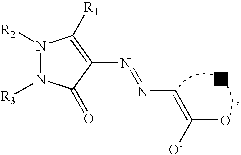
wherein Y represents an atom group forming a five-membered or six-membered heterocyclic ring which may be condensed, and each of R1, R2, and R3 independently represents a hydrogen atom or a substituent.

4. The optical information-recording medium according to claim 1, wherein said ligand of said general formula (I) is a compound represented by the following general formula (IIb): 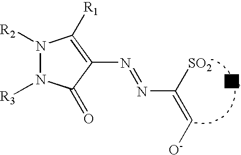
wherein Y represents an atom group forming a five-membered or six-membered heterocyclic ring which may be condensed, and each of R1, R2, and R3 independently represents a hydrogen atom or a substituent.

5. The optical information-recording medium according to claim 4, wherein said five-membered or six-membered heterocyclic ring formed by the atom group represented by Y in said general formula (IIb), which may be condensed, contains no nitrogen atom.

6. The optical information-recording medium according to claim 1, wherein said metal complex having said ligand of said compound represented by said general formula (I) is a compound represented by the following general formula (IIIa): 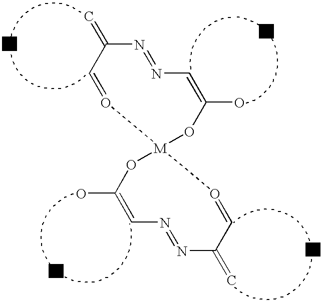
wherein broken lines represent coordinate bonds, each of X and Y independently represents an atom group forming a five-membered or six-membered heterocyclic ring which may be condensed, and M is any one of Ni, Cu, Co, Zn, Al, Fe, Pd, Cr, and Mn.

7. The optical information-recording medium according to claim 1, wherein said metal complex having said ligand of said compound represented by said general formula (I) is a compound represented by the following general formula (IIIb): 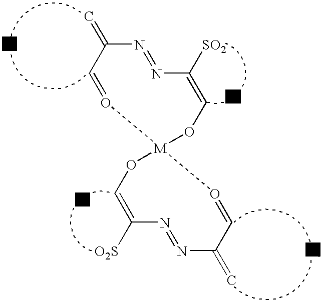
wherein broken lines represent coordinate bonds, each of X and Y independently represents an atom group forming a five-membered or six-membered heterocyclic ring which may be condensed, and M is any one of Ni, Cu, Co, Zn, Al, Fe, Pd, Cr, and Mn.

8. The optical information-recording medium according to claim 1, wherein:
said substrate is a transparent disk-shaped substrate which has a pregroove having a track pitch of 50 to 600 nm on a surface; and
said recording layer is provided on said surface of said substrate disposed on a side on which said pregroove is formed.

9. The optical information-recording medium according to claim 1, wherein a light-reflective layer, which is composed of a metal, is provided distinctly from said recording layer.

10. The optical information-recording medium according to claim 1, wherein a protective layer is provided distinctly from said recording layer.

11. An information-recording method comprising recording information by radiating a laser beam having a wavelength of not more than 440 nm onto said optical information-recording medium as defined in claim 1.

12. A compound represented by the following general formula (IVa): 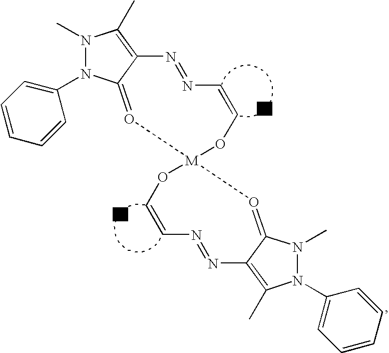
wherein broken lines represent coordinate bonds, A represents an atom group selected from the following group 1a, and M is any one of Ni, Cu, Co, Zn, and Cr, the group 1a being as follows: 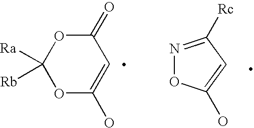
wherein each of Ra, Rb, and Rc represents a hydrogen atom or a substituent, said respective substituents may be bonded to one another to form a ring, and a symbol * indicates a position of bonding to an azo group.

13. A compound represented by the following general formula (IVb): 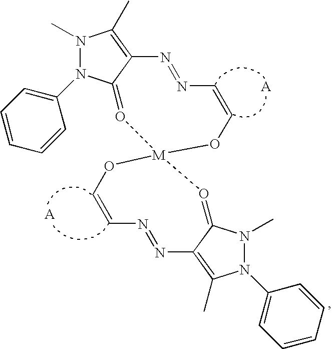
wherein broken lines represent coordinate bonds, A represents an atom group selected from the following group 1b, and M is any one of Ni, Cu, Co, Zn, and Cr: the group 1b being as follows: 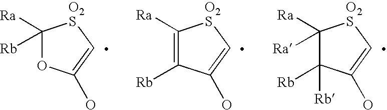
wherein each of Ra, Ra′, Rb, and Rb′ represents a hydrogen atom or a substituent, said respective substituents may be bonded to one another to form a ring, and a symbol * indicates a position of bonding to an azo group.
